(19) United States
(12) Patent Application Publication
(10) Pub. No.: US 2025/0131410 A1
(43) Pub. Date: Apr. 24, 2025

(54) PAYMENT METHODS, APPARATUSES, AND DEVICES BASED ON NEAR FIELD COMMUNICATION, AND MEDIA

(71) Applicant: Alipay (Hangzhou) Information Technology Co., Ltd., Hangzhou (CN)

(72) Inventors: Senyan ZHANG, Hangzhou (CN); Jianji XU, Hangzhou (CN); Kai ZHENG, Hangzhou (CN); Hao LUO, Hangzhou (CN)

(21) Appl. No.: 18/938,034

(22) Filed: Nov. 5, 2024

Related U.S. Application Data
(63) Continuation-in-part of application No. 18/775,724, filed on Jul. 17, 2024.

(30) Foreign Application Priority Data
Jul. 18, 2023 (CN) 202310884417.8

(51) Int. Cl. G06Q 20/32; G06Q 20/40

(52) U.S. Cl. CPC G06Q 20/3278; G06Q 20/4014

(57) ABSTRACT

Embodiments of this specification disclose payment methods, apparatuses, and devices based on near field communication, and media. The solution includes: sending, by a mobile terminal with a near field communication function, an electromagnetic signal used to trigger an NFC tag; obtaining tag information in the NFC tag in response to the electromagnetic signal, where the tag information includes payment link information; displaying, based on the payment link information, a payment page including user information of a first transaction party; obtaining payment information provided by a second transaction party based on the payment page; and sending a payment processing request including the payment information to a server, where the server is configured to complete payment based on the payment processing request.

### CROSS-REFERENCE TO RELATED APPLICATIONS

This application is a continuation-in-part of U.S. patent application Ser. No. 18/775,724, filed Jul. 17, 2024, which claims priority to Chinese Patent Application No. 202310884417.8, filed with the China National Intellectual Property Administration on Jul. 18, 2023, both of which are incorporated here by reference in their entireties.

### TECHNICAL FIELD

This application relates to the field of computer technologies, and in particular, to payment methods, apparatuses, and devices based on near field communication, and media.

### BACKGROUND

With development of computer technologies, mobile payment based on a payment code becomes more popular, and greatly improves payment experience of a user. However, as mobile applications develop, applications such as games, novels, and short videos occupy a terminal screen for more time. When payment needs to be performed, the user needs to exit a current application, find a payment application with a payment function from an application list of a mobile terminal, and enable a code scanning function or display a payment code in the payment application. In this way, user operations are relatively complex.

Therefore, how to simplify payment operations of the user and improve user experience is an urgent technical problem to be resolved.

### SUMMARY

Embodiments of this specification provide payment methods, apparatuses, and devices based on near field communication, and media, to resolve a problem that user operations are complex in an existing payment method.

To resolve the above-mentioned technical problem, the embodiments of this specification are implemented as follows:

One or more embodiments of this specification provide a near field communication-based payment method, including: sending, by a mobile terminal with a near field communication function, an electromagnetic signal used to trigger an NFC tag; obtaining tag information in the NFC tag in response to the electromagnetic signal, where the tag information includes payment link information; displaying, based on the payment link information, a payment page including user information of a first transaction party; obtaining payment information provided by a second transaction party based on the payment page; and sending a payment processing request including the payment information to a server, where the server is configured to complete payment based on the payment processing request.

One or more embodiments of this specification provide a near field communication-based payment method, including: sending, by a mobile terminal with a near field communication function, an electromagnetic signal used to trigger an NFC tag; obtaining tag information in the NFC tag in response to the electromagnetic signal, where the tag information is used to trigger a payment procedure; obtaining, based on the tag information, transaction identification information used to indicate user payment account information in the mobile terminal; and sending the transaction identification information to a payment device associated with the NFC tag, where the payment device is configured to execute the payment procedure based on the transaction identification information.

One or more embodiments of this specification provide a near field communication-based payment method, including: obtaining, by a mobile terminal with a near field communication function, tag information in an NFC tag associated with a payment device; starting a payment application in the mobile terminal based on the tag information; sending a payment processing request to a server based on the started payment application, where the server is configured to: process a payment service based on the payment processing request, and feed back payment result information; and displaying a transaction result page based on the payment result information fed back by the server.

One or more embodiments of this specification provide a near field communication-based payment method, including: obtaining, by a server, a payment processing request that includes payment information and that is sent by a mobile terminal with a near field communication function, where the payment information is provided by a second transaction party based on a displayed payment page including user information of a first transaction party, the payment page is generated by the mobile terminal based on obtained tag information in an NFC tag, and the tag information includes payment link information; and completing a payment service for the first transaction party and the second transaction party based on the payment processing request.

One or more embodiments of this specification provide a near field communication-based payment method, including: obtaining, by a server, a payment information obtaining request generated by a mobile terminal with a near field communication function based on obtained tag information in an NFC tag, where the tag information is used to trigger a payment procedure; generating, based on the payment information obtaining request, transaction identification information used to indicate user payment account information in the mobile terminal; and sending the transaction identification information to a payment device associated with the NFC tag, where the payment device is configured to execute a payment procedure based on the transaction identification information.

One or more embodiments of this specification provide a near field communication-based payment method, including: obtaining, by a server, a payment processing request sent by a mobile terminal, where the payment processing request is sent by a payment application started by the mobile terminal based on tag information in an NFC tag; processing a payment service based on the payment request to generate payment result information; and feeding back the payment result information to the mobile terminal.

One or more embodiments of this specification provide a near field communication-based payment apparatus, including: a triggering information sending module, configured to send an electromagnetic signal used to trigger an NFC tag; a tag information obtaining module, configured to obtain tag information in the NFC tag in response to the electromagnetic signal, where the tag information includes payment link information; a page display module, configured to display, based on the payment link information, a payment page including user information of a first transaction party; a payment information obtaining module, configured to obtain payment information provided by a second transaction party based on the payment page; and a request sending module, configured to send a payment processing request including the payment information to a server, where the server is configured to complete payment based on the payment processing request.

One or more embodiments of this specification provide a near field communication-based payment apparatus, including: a triggering information sending module, configured to send an electromagnetic signal used to trigger an NFC tag; a tag information obtaining module, configured to obtain tag information in the NFC tag in response to the electromagnetic signal, where the tag information is used to trigger a payment procedure; a transaction identifier obtaining module, configured to obtain, based on the tag information, transaction identification information used to indicate user payment account information in the mobile terminal; and a transaction identifier sending module, configured to send the transaction identification information to a payment device associated with the NFC tag, where the payment device is configured to execute a payment procedure based on the transaction identification information.

One or more embodiments of this specification provide a near field communication-based payment apparatus, including: a tag information obtaining module, configured to obtain tag information in an NFC tag associated with a payment device; an application start module, configured to start a payment application in the mobile terminal based on the tag information; a request sending module, configured to send a payment processing request to a server based on the started payment application, where the server is configured to: process a payment service based on the payment processing request, and feed back payment result information; and a page display module, configured to display a transaction result page based on the payment result information fed back by the server.

One or more embodiments of this specification provide a near field communication-based payment apparatus, including: a request obtaining module, configured to obtain a payment processing request that includes payment information and that is sent by a mobile terminal with a near field communication function, where the payment information is provided by a second transaction party based on a displayed payment page including user information of a first transaction party, the payment page is generated by the mobile terminal based on obtained tag information in an NFC tag, and the tag information includes payment link information; and a request processing module, configured to complete a payment service for the first transaction party and the second transaction party based on the payment processing request.

One or more embodiments of this specification provide a near field communication-based payment apparatus, including: a request obtaining module, configured to obtain a payment information obtaining request generated by a mobile terminal with a near field communication function based on obtained tag information in an NFC tag, where the tag information is used to trigger a payment procedure; an information generation module, configured to generate, based on the payment information obtaining request, transaction identification information used to indicate user payment account information in the mobile terminal; and a sending module, configured to send the transaction identification information to a payment device associated with the NFC tag, where the payment device is configured to execute a payment procedure based on the transaction identification information.

One or more embodiments of this specification provide a near field communication-based payment apparatus, including: a request obtaining module, configured to obtain a payment processing request sent by a mobile terminal, where the payment processing request is sent by a payment application started by the mobile terminal based on tag information in an NFC tag; a payment processing module, configured to process a payment service based on the payment request to generate payment result information; and a result sending module, configured to feed back the payment result information to the mobile terminal.

One or more embodiments of this specification provide a near field communication-based payment device, including: at least one processor, and a storage communicatively connected to the at least one processor. The storage stores instructions capable of being executed by the at least one processor, and the instructions are executed by the at least one processor, so that the at least one processor is capable of performing a near field communication-based payment method.

One or more embodiments of this specification provide a computer-readable medium. The computer-readable medium stores computer-readable instructions, and the computer-readable instructions are capable of being executed by a processor to implement a payment method based on near field communication.

The following beneficial effects can be achieved in at least one embodiment of this specification: In one or more embodiments of this specification, a mobile terminal can obtain payment link information in an NFC tag through near field communication, the mobile terminal can display a payment page based on the information, and a user can input payment information such as a payment amount on the payment page to complete payment. In this way, there is no need for the user to find a payment application and then perform a corresponding payment operation in the payment application. For example, in a scenario in which payment is performed by scanning a payment code, there is no need for the user to find a payment application and then select a code scanning function in the payment application. In the one or more embodiments of this specification, the mobile terminal can display the payment page based on the information in the NFC tag, to simplify user operations and improve user experience.

In at least one embodiment, a mobile terminal obtains, through near field communication, tag information that is in an NFC tag and that is used to trigger a payment procedure, obtains transaction identification information, and sends the transaction identification information to a payment device for payment. In this way, there is no need for the user to find a payment application and then perform a corresponding payment operation in the payment application. For example, in a scenario in which a payment code needs to be displayed and scanned by the payment device for payment, there is no need for the user to find a payment application and then select a payment code in the payment application for display. In one or more embodiments of this specification, the mobile terminal can send, to the payment device based on the information in the NFC tag, transaction identification information used to perform payment, to simplify user operations and improve user experience.

In at least one embodiment, a mobile terminal can obtain tag information in an NFC tag through near field communication, start a payment application in the mobile terminal, and initiate a payment processing request to a server. The server can process a payment service and feed back result information to the mobile terminal. In this way, payment can be triggered through NFC, and payment is performed without a user manually identifying a payment application and then manually starting the payment application, to simplify user operations and improve user experience.

### BRIEF DESCRIPTION OF DRAWINGS

To describe the technical solutions in the embodiments of this specification or in a conventional technology more clearly, the following briefly describes the accompanying drawings needed for describing the embodiments or the conventional technology. Clearly, the accompanying drawings in the following descriptions merely show some embodiments of this specification, and a person of ordinary skill in the art can still derive other drawings from these accompanying drawings without creative efforts.

FIG. 1 is a schematic diagram illustrating an application scenario of a payment method based on near field communication, according to one or more embodiments of this specification;

FIG. 2 is a schematic flowchart illustrating a payment method based on near field communication, according to one or more embodiments of this specification;

FIG. 3 is a swimlane diagram illustrating a payment method based on near field communication, according to one or more embodiments of this specification;

FIG. 4 is a schematic diagram illustrating an application scenario of a payment method based on near field communication, according to one or more embodiments of this specification;

FIG. 5 is a schematic flowchart illustrating a payment method based on near field communication, according to one or more embodiments of this specification;

FIG. 6 is a swimlane diagram illustrating a payment method based on near field communication, according to one or more embodiments of this specification;

FIG. 7 is a schematic flowchart illustrating a near field communication-based payment method, according to one or more embodiments of this specification;

FIG. 8 is a schematic diagram illustrating a payment prompt page, according to one or more embodiments of this specification;

FIG. 9 is a schematic diagram illustrating a payment page, according to one or more embodiments of this specification;

FIG. 10 is a schematic diagram illustrating a transaction result page, according to one or more embodiments of this specification;

FIG. 11 is a schematic diagram illustrating display of prompt information, according to one or more embodiments of this specification;

FIG. 12 is a schematic diagram illustrating display of prompt information, according to one or more embodiments of this specification;

FIG. 13 is a schematic diagram illustrating display of prompt information, according to one or more embodiments of this specification;

FIG. 14 is a schematic diagram illustrating a setting page, according to one or more embodiments of this specification;

FIG. 15 is a schematic diagram illustrating a payment response page, according to one or more embodiments of this specification;

FIG. 16 is a schematic flowchart illustrating a payment method based on near field communication, according to one or more embodiments of this specification;

FIG. 17 is a schematic flowchart illustrating a payment method based on near field communication, according to one or more embodiments of this specification;

FIG. 18 is a schematic flowchart illustrating a payment method based on near field communication, according to one or more embodiments of this specification;

FIG. 19 is a schematic diagram illustrating a structure of a payment apparatus based on near field communication corresponding to FIG. 2, according to one or more embodiments of this specification;

FIG. 20 is a schematic diagram illustrating a structure of a payment apparatus based on near field communication corresponding to FIG. 5, according to one or more embodiments of this specification;

FIG. 21 is a schematic diagram illustrating a structure of a payment apparatus based on near field communication corresponding to FIG. 7, according to one or more embodiments of this specification;

FIG. 22 is a schematic diagram illustrating a structure of a payment apparatus based on near field communication corresponding to FIG. 16, according to one or more embodiments of this specification;

FIG. 23 is a schematic diagram illustrating a structure of a payment apparatus based on near field communication corresponding to FIG. 17, according to one or more embodiments of this specification;

FIG. 24 is a schematic diagram illustrating a structure of a payment apparatus based on near field communication corresponding to FIG. 18, according to one or more embodiments of this specification; and

FIG. 25 is a schematic diagram illustrating a structure of a payment device based on near field communication according to one or more embodiments of this specification.

### DESCRIPTION OF EMBODIMENTS

To make the objectives, technical solutions, and advantages of one or more embodiments of this specification clearer, the following clearly and comprehensively describes the technical solutions in the one or more embodiments of this specification with reference to corresponding accompanying drawings and specific embodiments of this specification. Clearly, the described embodiments are merely some but not all of the embodiments of this specification. All other embodiments obtained by a person of ordinary skill in the art based on the embodiments of this specification without creative efforts shall fall within the protection scope of the one or more embodiments of this specification.

The following describes in detail the technical solutions provided in the embodiments of this specification with reference to the accompanying drawings.

In the conventional technology, when buying a product, a user usually needs to display a payment code or scan a collection code of a merchant, to perform payment. Usually, the user needs to find a payment application in a mobile terminal, and then select a payment code or a code scanning function, to perform payment. If the user is using another application in the mobile terminal before payment, for example, is reading an e-book or a video, the user needs to exit a current application, find the payment application, and find the payment code or the code scanning function. In this way, user operations are relatively complex.

To overcome a disadvantage in the conventional technology, the solutions provide the following embodiments. FIG. 1 is a schematic diagram illustrating an application scenario of a payment method based on near field communication, according to one or more embodiments of this specification. As shown in FIG. 1, this solution can include a mobile terminal 1 with a near field communication function, an NFC tag 2 carrying tag information, and a server 3 configured to process a payment service. When the mobile terminal 1 approaches the NFC tag 2, and the mobile terminal 1 and the NFC tag 2 are at a specific distance, the NFC tag can be triggered, to obtain the tag information included in the NFC tag 2. The tag information can include payment link information used to display a payment page. The mobile terminal 1 can display the payment page based on the obtained tag information. A user can enter information such as a payment amount on the payment page. The mobile terminal 1 can send a payment request including payment information to the server 3. The server 3 can process the payment request to complete payment.

The following specifically describes, with reference to the accompanying drawings, the payment method based on near field communication provided in the embodiments of this specification.

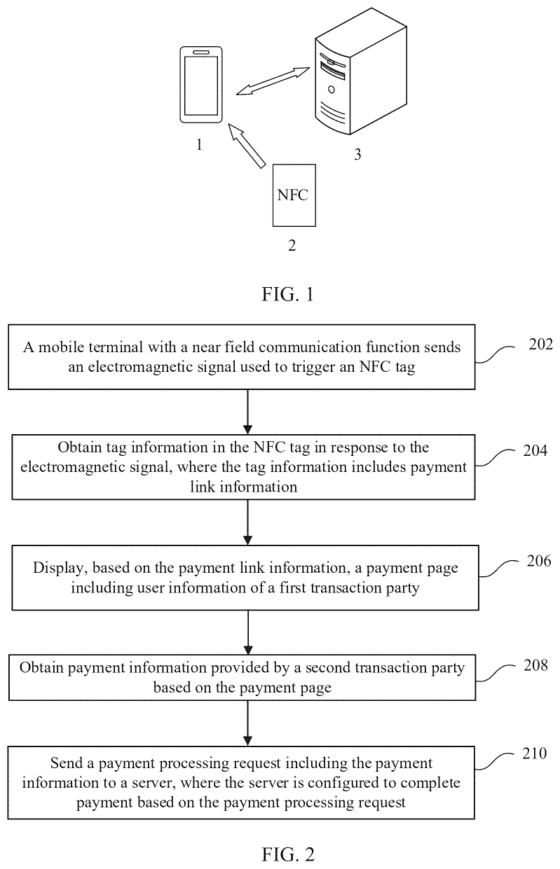

FIG. 2 is a schematic flowchart illustrating a payment method based on near field communication, according to one or more embodiments of this specification. From a program perspective, a procedure can be performed by a program or an application client integrated into an application server or a terminal application.

As shown in FIG. 2, the procedure can include step 202 to step 210.

Step 202: A mobile terminal with a near field communication function sends an electromagnetic signal used to trigger an NFC tag.

Near field communication (NFC) is a near field communication technology. The mobile terminal can have the near field communication (NFC) function. The mobile terminal can include a mobile terminal such as a portable terminal or a wearable terminal, for example, a mobile phone or a smartwatch. Near field communication, also referred to as short-range wireless communication, is a short-range high-frequency wireless communication technology, and allows contactless point-to-point data transmission and data exchange between electronic devices. In one or more embodiments of this specification, the NFC tag can be a passive electronic tag or an electronic chip, and when the mobile terminal with a near field communication function approaches the NFC tag, the NFC tag generates an induction signal with the mobile terminal, to transmit data. After the near field communication function is enabled, the mobile terminal can send an electromagnetic signal, and can activate an NFC tag within a preset distance, to perform data transmission. For a specific NFC communication process, references can be made to an existing NFC communication technology. Details are omitted here for simplicity.

Step 204: Obtain tag information in the NFC tag in response to the electromagnetic signal, where the tag information includes payment link information.

To-be-transmitted tag information can be pre-written to the NFC tag. In one or more embodiments of this specification, the tag information can include link information for payment, for example, can include a payment application that needs to be invoked and the payment link information. The mobile terminal can invoke and display a payment page based on the obtained tag information.

Step 206: Display, based on the payment link information, a payment page including user information of a first transaction party.

The first transaction party can be understood as an owner of the NFC tag. The first transaction party can represent a payee if the NFC tag is a tag used for collection; and the first transaction party can represent a payer if the NFC tag is a tag used for payment. The tag information in the NFC tag can be generated based on transaction party information provided by the first transaction party. In actual applications, payment link information used to invoke the payment page can be written to the NFC tag based on an NFC communication protocol.

Step 208: Obtain payment information provided by a second transaction party based on the payment page.

The second transaction party and the first transaction party can represent two parties that have a transaction relationship. For example, if the NFC tag is a tag used for collection, the first transaction party can represent a payee, and the second transaction party can represent a payer; or if the NFC tag is a tag used for payment, the first transaction party can represent a payer, and the second transaction party can represent a payee. The payment page can include an area for filling in or selecting payment information such as a payment amount and a payment manner, and can fill in transaction information based on an actual transaction need. In one or more embodiments of this specification, the payment page can be the same as or similar to an existing payment page accessed by scanning a payment code such as a two-dimensional code by a mobile terminal, and a user can provide the payment information in an existing common operation manner. This can be more consistent with a user habit. In actual applications, a layout, a format, content, etc. of the payment page can be set based on an actual need, and is not specifically limited here. For example, in actual applications, the first transaction party can set transaction amount information based on an actual transaction need, or the second transaction party can set a transaction amount. In this case, the payment page can include transaction amount information set by the first transaction party or the second transaction party based on a needed payment amount. The second transaction party can perform an operation that indicates confirmation of the transaction information, for example, tapping a confirmation control.

Alternatively, after a preset time period, for example, within a 3-second or 5-second countdown, if the user does not cancel payment, for example, the user does not tap a “Cancel” control, it can indicate that the second transaction party has confirmed the information on the payment page. The mobile terminal can obtain payment information including the transaction amount information.

It can be understood that the second transaction party can perform some substantive operations on the payment page, for example, tapping a control indicating confirmation or filling in a payment amount; or perform a real operation on the payment page, for example, determining or selecting a payment manner. The second transaction party can further perform a non-substantive operation on the payment page. For example, the payment page can display countdown information; or the payment page does not display countdown information, instead, a countdown program is performed in the background of the mobile terminal. If the user does not perform an operation on the payment page before the countdown ends, for example, the user does not perform an operation of canceling payment, it can indicate that the user agrees to perform payment, or can indicate that the user has confirmed the payment information. If the user does not perform the operation of canceling payment, it can indicate that the user does not perform a substantive operation on the payment page, or can indicate that the user performs an operation of an inaction type on the payment page. In other words, in the one or more embodiments of this specification, the obtaining payment information provided by a second transaction party based on the payment page can include: obtaining the payment information provided by the second transaction party by performing a substantive operation or a non-substantive operation on the payment page. Implementations are not specifically limited here.

Step 210: Send a payment processing request including the payment information to a server, where the server is configured to complete payment based on the payment processing request.

The mobile terminal can generate the payment processing request based on the payment information provided by the user, and send the payment processing request to the server, so that the server can process a complete payment service based on the received payment processing request. The payment processing request can include the payment information such as transaction party information, a transaction amount, and a transaction manner, so that the server can complete payment for two transaction parties. In actual applications, a payment manner or a transaction manner can include a payment account provided by a financial institution, for example, a bank card account of a bank; can include a payment account of a third-party payment application, for example, a payment account corresponding to the second transaction party in a third-party payment application; or can include a payment account of another user associated with the second transaction party, such as family payment.

It should be understood that in the method described in one or more embodiments of this specification, sequences of some steps in the method can be exchanged with each other based on an actual need, or some steps in the method can be omitted or deleted. For example, to further improve payment efficiency, if the tag information in the NFC tag includes the payment information, for example, the first transaction party has written information such as a transaction amount or an order number into the tag information in the NFC tag based on an actual need, step 206 and step 208 can be omitted, a payment procedure can be triggered based on the tag information, and a payment request can be sent to the server, so that the server processes the payment request to complete payment.

In the method in FIG. 2, the mobile terminal can obtain the payment link information in the NFC tag through near field communication, the mobile terminal can display the payment page based on the information, and the user can complete payment by entering the payment information such as the payment amount on the payment page. In this way, there is no need for the user to find a payment application and then perform a corresponding payment operation in the payment application. For example, in a scenario in which payment is performed by scanning a payment code, there is no need for the user to find a payment application and then select a code scanning function in the payment application. In the one or more embodiments of this specification, the mobile terminal can display the payment page based on the information in the NFC tag, to simplify user operations and improve user experience.

In a common NFC payment solution in the conventional technology, for example, NFC card payment for a bus, a subway, etc., the mobile terminal such as a mobile phone is simulated as an NFC card; information in the NFC card is sent to a payment device such as a bus card reader or a subway gate machine based on a near field communication technology; and then the payment device completes payment. The payment device needs to be laid at a specific scenario location, and the payment device is equivalent to an NFC card reader. In this way, costs are relatively high.

In actual applications, most mobile terminals have a near field communication function and have a near field communication module. In one or more embodiments of this specification, the mobile terminal is equivalent to the NFC card reader. The NFC tag can be a passive electronic tag. A payment procedure can be simplified based on a function of the mobile terminal. In addition, the NFC tag has a small size, and can be conveniently placed at a location at which payment needs to be performed. An existing hardware device does not need to be changed or changed too much, and costs are low. This can be applied to a plurality of situations, and an application scope can be wider.

In addition, in the one or more embodiments of this specification, through near field communication, when the mobile terminal approaches an NFC tag including information used for payment, the mobile terminal can display a payment page. The user provides payment information on the payment page. The payment page can be the same as a payment page presented by scanning a code by the user by using the mobile terminal. The server processing the payment request can process the payment request through an existing processing link, without a need to set up a new service processing link. In this way, workload of a developer can be reduced, and overheads of the server can be reduced, to help speed up implementation of an NFC communication payment manner.

Based on the method in FIG. 2, one or more embodiments of this specification further provide some specific implementations of the method, which are described below.

In actual applications, payment can be performed by using a payment application with a payment function in the mobile terminal. Optionally, in one or more embodiments of this specification, the tag information can include instruction information used to start the payment application. The displaying, based on the payment link information, a payment page including user information of a first transaction party can specifically include: starting the payment application in the mobile terminal based on the instruction information; and displaying the payment page corresponding to the first transaction party based on the started payment application.

The payment application can represent a terminal application with a payment function. After obtaining, through near field communication, instruction information that is in the tag information and that is used to start the payment application, the mobile terminal can start the payment application in the mobile terminal, and then display the payment page based on the started payment application. The payment page can indicate an application page of the payment application.

The instruction information can include an application identifier of a to-be-started payment application. After reading the instruction information, the mobile terminal can determine the payment application based on the application identifier. In actual applications, whether the payment application exists in the mobile terminal can be further determined. If the payment application does not exist in the mobile terminal, prompt information indicating that payment cannot be performed can be generated, or prompt information indicating that the user downloads and installs the payment application can be generated; or the payment application can be started if the payment application exists in the mobile terminal.

In actual applications, the NFC tag information can include information used to represent a to-be-processed service, for example, can include information used to display the payment page. The mobile terminal can display the payment page based on the tag information. Optionally, in one or more embodiments of this specification, the tag information can include request identification information used to request to obtain payment page information. The displaying the payment page based on the started payment application can specifically include following: The payment application in a started state generates a payment page information obtaining request based on the request identification information; sends the payment page obtaining request to the server; obtains payment page information that is generated by the server based on the payment page obtaining request and that includes the user information of the first transaction party; and displays, based on the payment page information, the payment page including the user information of the first transaction party.

The tag information can include information about the first transaction party, for example, merchant identification information, and can further include token information for requesting the server to provide information needed for the payment page. The mobile terminal or the started payment application can send the payment page information obtaining request to the server. The server can generate the payment page information based on the user information of the first transaction party, and feed back the payment page information to the mobile terminal. The mobile terminal can render and display the payment page based on the obtained payment page information. In implementations and applications, the payment page information can alternatively be generated by the mobile terminal. For example, the mobile terminal can include a page template of the payment page. If the NFC tag information includes information such as a name, a nickname, and an account identifier of the first transaction party, the mobile terminal can supplement the information about the first transaction party to the page template, and can further determine a payment manner used by a user who logs in to the mobile terminal. Information about the payment manner is also added to the page template, and the payment page can be generated and displayed.

In actual applications, the payment page can include the information about the first transaction party, for example, a merchant name, a payee nickname, partial collection account information, or a payee name, can further include an area used to fill in or select a payment amount, and can further include a control used to determine the payment information, for example, a submission control or a payment confirmation control. In actual applications, after the user submits the payment information, a payment password input page can be further displayed, so that the user enters a password to perform payment.

In the one or more embodiments of this specification, a transaction party can be further verified, to ensure payment security. Optionally, in one or more embodiments of this specification, the tag information can include user identification information of the first transaction party, for example, payee information or merchant information. The method in one or more embodiments of this specification can further include: determining, based on the user identification information, whether the first transaction party has transaction permission, to obtain a determining result; and the displaying a payment page including user information of a first transaction party can specifically include: if the determining result indicates that the first transaction party has the transaction permission, displaying the payment page including the user information of the first transaction party.

In actual applications, validity and compliance of the transaction party can be verified. A server with a verification function can store information about a transaction party with transaction permission, for example, a list of transaction parties with transaction permission. Whether the first transaction party is a transaction party with transaction permission can be determined, or whether the first transaction party is located in the list of transaction parties with transaction permission is determined. If yes, it can be determined that the first transaction party has transaction permission. A third party can also verify compliance of the transaction party, etc. A specific verification manner is not specifically limited here.

In the conventional technology, a payment code such as a two-dimensional code is usually placed on a checkout counter or pasted in a place convenient for payment by the user, or can be carried on a merchant. In one or more embodiments of this specification, the NFC tag can be carried on an existing payment code card, for example, pasted or placed at a location that does not affect identification of the two-dimensional code, for example, on a back or a side of a two-dimensional code image, and an independent carrier can be disposed to place the NFC tag. Optionally, in one or more embodiments of this specification, the NFC tag can be located in a carrier including a payment code of the first transaction party, or can be located in a carrier that does not include a payment code of the first transaction party. The payment code can be understood as a scannable payment code image in an image form, for example, a common two-dimensional code.

Because the NFC tag has a small size, in one or more embodiments of this specification, the NFC tag can be placed at any location convenient for payment by the user, for example, can be placed on a back of the carrier of the payment code or a front location that does not affect the payment code. When the user moves the mobile terminal to approach or abut the carrier, a payment procedure can be entered, and the payment page is displayed. An NFC payment card can also be disposed. The payment card can include an NFC payment identifier. When the user moves the mobile terminal to approach or abut the payment card, a payment procedure can also be entered, and the payment page is displayed.

In actual applications, before performing payment, the user may be processing another service by using the mobile terminal, for example, is watching a video, playing a game, reading an e-book, reading news, or communicating with another user through instant messaging. In one or more embodiments of this specification, the user can perform payment without a need to exit a current application that is being used before payment. Optionally, in one or more embodiments of this specification, if the mobile terminal is displaying an application page of a second application when obtaining the tag information that is in the NFC tag and that includes the payment link information, the displaying the payment page corresponding to the first transaction party can specifically include: displaying the payment page at an upper layer of the application page of the second application through superimposition.

In actual applications, the payment page can be displayed in a partial area or a whole area on the application page of the second application.

Optionally, the method in the one or more embodiments of this specification can further include: obtaining an exit operation performed by the second transaction party on the payment page; and switching to the application page of the second application based on the exit operation for display.

The payment page can include a control used to indicate to exit the payment page, for example, a payment confirmation control or a close control. The user can exit the payment page by performing an operation on the control, or can exit the payment page by performing a preset operation on the payment page, for example, a sliding operation in a preset direction such as a leftward sliding operation, a rightward sliding operation, an upward sliding operation, or a downward sliding operation. In one or more embodiments of this specification, after the payment page is exited, an application page displayed by the mobile terminal before payment can continue to be displayed, to further improve user experience.

In one or more embodiments of this specification, after the user submits the payment information or enters the payment password, a page indicating a transaction result can be further displayed. A transaction result page can also be superimposed at an upper layer of the partial area or the whole area of the application page of the second application. The transaction result page can also include a control used to exit or close the page. After the page is exited or closed, the application page of the second application can continue to be displayed.

In actual applications, after obtaining the information indicating the transaction result, the mobile terminal can further generate prompt information indicating the transaction result, for example, an SMS message or a prompt tone, or can display the prompt information on the application page of the second application.

In actual applications, when the merchant allows a plurality of payment applications for payment, after the mobile terminal approaches or abuts the NFC tag, a page for the user to select a payment application can be further displayed, and the user can select a payment application to perform payment. Optionally, in one or more embodiments of this specification, the tag information can include first triggering information, the first triggering information is used to trigger the mobile terminal to determine a terminal application with a payment function in the mobile terminal and generate an application selection page, and the method in one or more embodiments of this specification can further include: determining the terminal application with the payment function in the mobile terminal in response to the first triggering information; generating the application selection page based on the terminal application with the payment function; and displaying the application selection page.

The application selection page can include an application identifier such as an icon of the terminal application with the payment function. Terminal applications can be sorted in a sequence of start time and then displayed, and a terminal application recently used by the user can be placed at a front location.

Optionally, in one or more embodiments of this specification, after the displaying the application selection page, the method can further include: obtaining a target terminal application selected by the second transaction party from the application selection page. The displaying, based on the payment link information, a payment page including user information of a first transaction party can specifically include: accessing the payment link information by using the target terminal application; and displaying, in the target terminal application, the payment page including the user information of the first transaction party.

Similar to the above-mentioned display manner of the payment page or the transaction result page, if the mobile terminal is using the second application before obtaining the tag information in the NFC tag, the application selection page can be displayed at the upper layer of the partial area or the whole area of the application page of the second application through superimposition. After the page is exited or closed by using a control used to exit or close the page or through a preset operation, the application page of the second application can continue to be displayed.

In actual applications, the payment page, the transaction result page, and the application selection page are equivalent to a page related to the payment procedure, and can be displayed above the application page of the second application in a semi-transparent manner or a non-transparent manner.

In actual applications, the mobile terminal can have a near field communication function, and can further have components such as a camera used to scan the payment code. To avoid disturbing the user and minimize resource consumption as much as possible, if the user has enabled the code scanning function, for example, has entered a code scanning function of a specific payment application, and is ready to perform payment by scanning a payment code by using the mobile terminal, an NFC payment procedure does not need to be started. Optionally, in one or more embodiments of this specification, before the obtaining tag information in the NFC tag in response to the electromagnetic signal, the method can include: determining whether the mobile terminal has started a code scanning application used to scan a payment code image. The obtaining tag information in the NFC tag in response to the electromagnetic signal can specifically include: obtaining the tag information in the NFC tag in response to the electromagnetic signal if the mobile terminal does not start the code scanning application used to scan the payment code image.

In actual applications, if the mobile terminal has started the code scanning application used to scan the payment code image, for example, the user has tapped “Scan” or another code scanning control in the payment application, a camera of the mobile terminal is in a started state, and information in the NFC tag can no longer be read, or a procedure that can be triggered by the information in the NFC tag is no longer executed.

It can be understood that, in one or more embodiments of this specification, the payment procedure can be triggered through near field communication only when the user grants authorization. For example, the user agrees to enable an NFC payment manner, and user information can be obtained and used for payment in a range for which the user grants authorization.

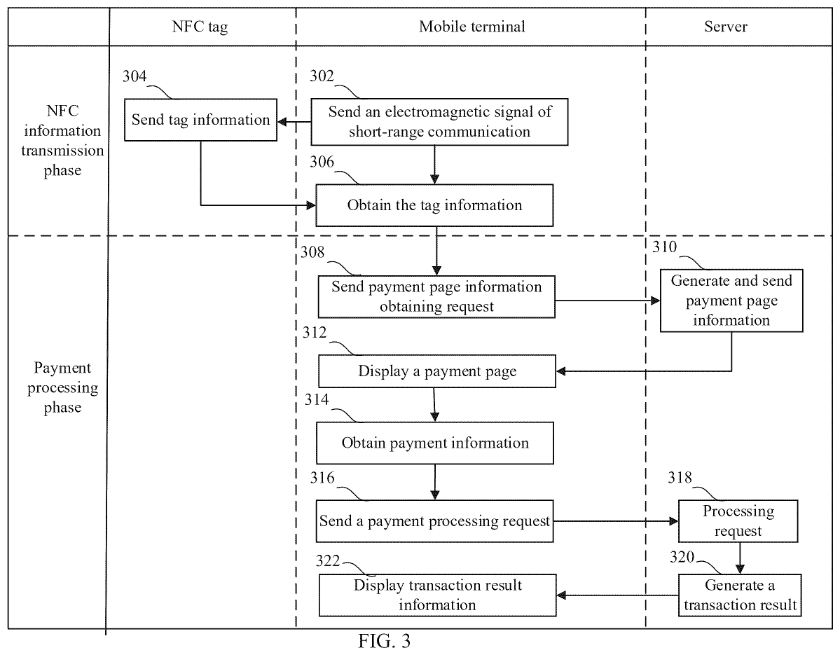

To describe more clearly the payment method based on near field communication provided in the embodiments of this specification, FIG. 3 is a swimlane diagram illustrating a payment method based on near field communication, according to one or more embodiments of this specification. As shown in FIG. 3, the solution can include an NFC information transmission phase and a payment processing phase, and can specifically include step 302 to step 322.

Step 302: A mobile terminal with a near field communication function sends an electromagnetic signal used to trigger an NFC tag. An NFC function of the mobile terminal can be enabled to send the electromagnetic signal, to trigger an NFC electronic tag or chip within a preset distance to establish near field communication.

Step 304: When the mobile terminal approaches or abuts the NFC tag, the mobile terminal can establish near field communication with the NFC tag, where the NFC tag can send tag information to the mobile terminal.

Step 306: The mobile terminal can obtain the tag information in the NFC tag in response to the electromagnetic signal. The tag information includes payment link information. The tag information can include identification information of a first transaction party, for example, a user ID, and can further include payment link information used to trigger a payment procedure. A payment application in the mobile terminal can be started based on the link information, and a payment page is displayed.

Step 308: Generate a payment page information obtaining request based on the payment link information, and send the payment page information obtaining request to a server. The payment link information can include the link information for starting the payment application. The mobile terminal can start the corresponding payment application, and then send the payment page information obtaining request to the server based on the payment application. The request can include the identification information of the first transaction party, for example, merchant identification information, and can further include a terminal identifier of the mobile terminal or an application user identifier of a user who logs in to the payment application in the mobile terminal, so that the server can determine two parties that carry out a transaction, and generate the payment page information.

Step 310: The server can generate the payment page information based on the obtaining request sent by the mobile terminal, and feed back the payment page information to the mobile terminal.

Step 312: The mobile terminal can display the payment page based on the obtained payment page information. The payment page can include an area used by a user to fill in payment information such as a payment amount and a payment manner.

Step 314: The user fills in the payment information on the payment page, and the mobile terminal can obtain the payment information provided by the user.

Step 316: The mobile terminal can generate a payment processing request based on the payment information provided by the user, and send the payment processing request to the server, to request the server to process the transaction.

Step 318: The server can obtain the payment processing request sent by the mobile terminal, and process the transaction based on transaction information such as information about two transaction parties included in the payment processing request or information about two transaction parties corresponding to the payment processing request, or a transaction amount.

Step 320: The server can further generate a transaction result, and feed back the transaction result to the mobile terminal.

Step 322: The mobile terminal can display transaction result information based on the transaction result fed back by the server.

In the conventional technology, a user can access a payment page by scanning a code by using the mobile terminal. In one or more embodiments of this specification, the payment page can be invoked through NFC short-range communication, to simplify user operations. It can be briefly understood that, the NFC tag in one or more embodiments of this specification can include information that is used to carry out the transaction and that is carried in a payment code, for example, a merchant identifier and a token that triggers a payment procedure in the conventional technology.

In an existing payment manner, the mobile terminal can further serve as a scanned object. For example, a payment code is displayed in the mobile terminal, and is scanned by a payment device to complete payment. In an existing manner, the user needs to open the payment application, find the payment code, and display the payment code. For example, if the user is using another application before payment, the user also needs to exit the application, and then find the payment application for payment. In this way, a relatively large quantity of user operation steps are needed. To simplify user operation steps and improve user experience, one or more embodiments of this specification further provide another payment method based on near field communication.

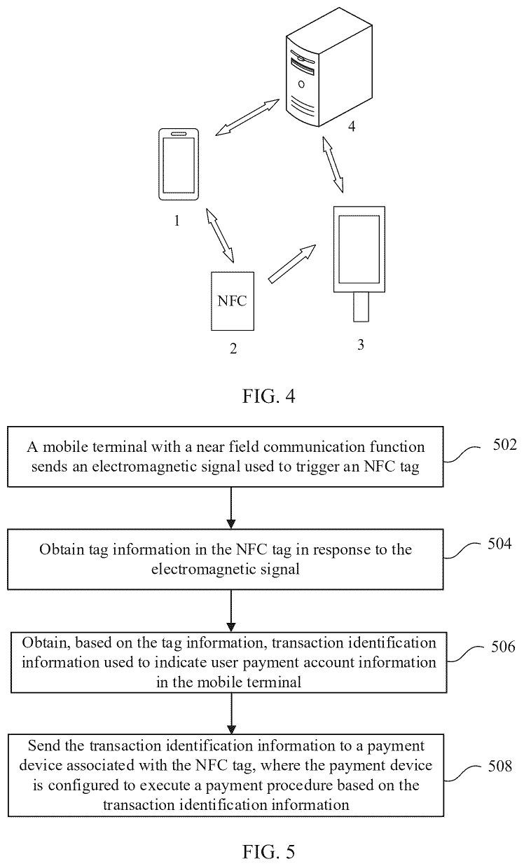

FIG. 4 is a schematic diagram illustrating an application scenario of a payment method based on near field communication, according to one or more embodiments of this specification. As shown in FIG. 4, the solution can include a mobile terminal 1 with a near field communication function, an NFC tag 2 carrying tag information, a payment device 3 associated with the NFC tag, and a server 4 configured to process a payment service. When the mobile terminal 1 approaches the NFC tag 2, and the mobile terminal 1 and the NFC tag 2 are at a specific distance, the NFC tag can be triggered to obtain tag information included in the NFC tag 2. The tag information can include information used to trigger a payment procedure. The mobile terminal 1 can send, based on the obtained tag information, a request for obtaining transaction identification information to the server 4. The server 4 can feed back, to the mobile terminal 1, transaction identification information indicating user payment account information in the mobile terminal. The mobile terminal 1 can send the transaction identification information to the payment device 3 through NFC communication. The server 4 can alternatively send the transaction identification information to the payment device 3 through network transmission. After obtaining the transaction identification information, the payment device 3 can send a payment processing request to the server 4. The server 4 can process a payment service between a user of the mobile terminal and a user of the payment device. Based on the schematic diagram of the scenario, FIG. 5 is a schematic flowchart illustrating a payment method based on near field communication, according to one or more embodiments of this specification. From a program perspective, a procedure can be performed by a program or an application client integrated into an application server or a terminal application.

As shown in FIG. 5, the procedure can include step 502 to step 508.

Step 502: A mobile terminal with a near field communication function sends an electromagnetic signal used to trigger an NFC tag.

Similar to a principle of the above-mentioned embodiments, the mobile terminal can include a mobile terminal such as a portable terminal or a wearable terminal, for example, a mobile phone or a smartwatch. Near field communication, also referred to as short-range wireless communication, is a short-range high-frequency wireless communication technology, and allows contactless point-to-point data transmission and data exchange between electronic devices. In one or more embodiments of this specification, the NFC tag can be a passive electronic tag or an electronic chip, and when the mobile terminal with the near field communication function approaches the NFC tag, the NFC tag generates an induction signal with the mobile terminal, to transmit data. After the near field communication function is enabled, the mobile terminal can send an electromagnetic signal, and can activate an NFC tag within a preset distance, to perform data transmission. For a specific NFC communication process, references can be made to an existing NFC communication technology. Details are omitted here for simplicity.

Step 504: Obtain tag information in the NFC tag in response to the electromagnetic signal, where the tag information is used to trigger a payment procedure.

The tag information can include information used to trigger the payment procedure, for example, information for starting a payment application or merchant information. The mobile terminal can obtain the information in the NFC tag through short-range communication, and trigger execution of the payment procedure.

Step 506: Obtain, based on the tag information, transaction identification information used to indicate user payment account information in the mobile terminal.

The transaction identification information can be used to determine a user payment account in the mobile terminal. The account can be a payment account if the tag information included in the NFC tag is a payment procedure used to perform payment, and the account can be a collection account if the tag information included in the NFC tag is a payment procedure used to perform collection. Implementations are not specifically limited here. In actual applications, a user can perform payment by using a terminal application with a payment function in the mobile terminal. The user payment account can also be a user account for logging in to the terminal application.

Step 508: Send the transaction identification information to a payment device associated with the NFC tag, where the payment device is configured to execute a payment procedure based on the transaction identification information.

The payment device can be understood as a device that can send a transaction request to a server that processes a transaction, and can be integrated with a program or a terminal application used to execute the payment procedure. In actual applications, the payment device can represent a device of another transaction party that carries out a transaction with a user of the mobile terminal. Specifically, the payment device can include a cash collection device, a self-check device, etc. The payment device can include the NFC tag, or the NFC tag can include a device identifier of the payment device, so that the payment device has a correspondence with the NFC tag. In actual applications, the payment device can further send, based on the payment procedure, a payment processing request to a server that processes a payment request, so that the server completes a payment transaction between two transaction parties.

In a scenario of performing payment by using the mobile terminal, the mobile terminal can represent a device of a payer, and the payment device can represent a device of a payee. In a scenario of performing collection by using the mobile terminal, the mobile terminal can represent a device of a payee, and the payment device can represent a device of a payer.

It should be understood that in the method described in one or more embodiments of this specification, sequences of some steps in the method can be exchanged with each other based on an actual need, or some steps in the method can be omitted or deleted.

In the method in FIG. 5, the mobile terminal obtains, through near field communication, the tag information that is in the NFC tag and that is used to trigger the payment procedure, obtains the transaction identification information, and sends the transaction identification information to the payment device for payment. In this way, there is no need for the user to find a payment application and then perform a corresponding payment operation in the payment application. For example, in a scenario in which a payment code needs to be displayed and scanned by the payment device for payment, there is no need for the user to find a payment application and then select a payment code in the payment application for display. In one or more embodiments of this specification, the mobile terminal can send, to the payment device based on the information in the NFC tag, transaction identification information used to perform payment, to simplify user operations and improve user experience.

To ensure payment security, the mobile terminal can request, based on an actual transaction need, the server to generate the transaction identification information. There can be different transaction identification information in different payment processes. Optionally, in one or more embodiments of this specification, the obtaining, based on the tag information, transaction identification information used to indicate user payment account information in the mobile terminal can specifically include: sending a payment information obtaining request including user identification information in the mobile terminal to a server; and obtaining the transaction identification information generated by the server based on the user identification information.

The user identification information can be a user ID, or can be identification information that can be used to determine the user payment account, for example, a device identifier of the mobile terminal or a user application identifier of the user in the terminal application. The server can determine the user payment account based on the user identification information, and generate transaction identification information that has a correspondence with the user payment account, to subsequently process a payment transaction by using the user payment account based on the transaction identification information. In actual applications, the transaction identification information can also be a character string such as payment QR code digits or a transaction order number, and the server can process the transaction between the two transaction parties based on the transaction identification information.

In one or more embodiments of this specification, a transaction identifier can be sent to the payment device through near field communication or through a network. In an implementation, in one or more embodiments of this specification, the sending the transaction identification information to a payment device can specifically include: sending the transaction identification information to the payment device through near field communication.

The payment device can have an NFC function, for example, has an NFC module, and can receive data sent through near field communication. The mobile terminal can send the transaction identification information to the payment device through near field communication. The sending the transaction identification information to the payment device through near field communication can specifically include: writing the transaction identification information to the NFC tag; and feeding back the transaction identification information to the payment device through near field communication based on the NFC tag.

Here, a tunnel mode of the NFC tag can be used. The transaction identification information is written to the NFC tag, and is directly transparently transmitted to the payment device. The NFC tag does not need to store the transaction identification information.

In another implementation, in one or more embodiments of this specification, the tag information can include the device identifier of the payment device, and the sending the transaction identification information to a payment device can specifically include: sending a payment request including the device identifier to the server. The server is configured to generate the transaction identification information, and send the transaction identification information to the payment device based on the device identifier.

In one or more embodiments of this specification, the server can generate the transaction identification information, and can further send the information to the payment device. In actual applications, a distance between the mobile terminal and the NFC tag needs to be relatively small for short-range communication, and a specific period of time is also needed for data transmission, and may be 1 second, 2 seconds, 3 seconds, etc. If the distance between the mobile terminal and the NFC tag falls within a preset range for relatively short duration, the transaction identification information may be unable to be transmitted through short-range communication. To ensure normal execution of the transaction, the transaction identification information can be sent to the payment device by using the server.

In actual applications, the above-mentioned two transmission manners can be sequentially or synchronously performed. The payment device can obtain the transaction identification information in any manner. Because the transaction identification information transmitted in the two transmission manners is the same, and the transaction identification information can be used only once, an entire payment system can ensure idempotence, to ensure normal execution of the transaction. If the payment device does not have a capability of obtaining information transmitted through near field communication, the transaction identification information can be sent to the payment device by using the server.

Similar to the above-mentioned embodiments, the tag information in one or more embodiments can include first link information used to start a payment application in the mobile terminal. The method in one or more embodiments of this specification can further include: starting the payment application based on the first link information; and the obtaining, based on the tag information, transaction identification information used to indicate user payment account information in the mobile terminal can specifically include: obtaining the transaction identification information based on the started payment application.

The tag information can include an identifier of a specified payment application. After obtaining the tag information, the mobile terminal can start the specified payment application, and perform payment based on the payment application. The transaction identification information can be transaction identification information fed back by the server to the payment application after the payment application sends a request to the server.

To improve a sense of security of the user for payment, in one or more embodiments of this specification, prompt information can be further generated, to notify the user that the payment application is started in the mobile terminal, so as to perform payment by using the payment application. Optionally, in one or more embodiments of this specification, after the starting the payment application, the method can further include: displaying prompt information used to indicate that the payment application is started. The prompt information can specifically include prompt information in a form of vibration, a sound, a text, an image, etc., and can further include a start page of the payment application, so that the user can perceive that the payment application is started.

In actual applications, the prompt information can be displayed at an upper layer or in a partial area of a page that is currently being displayed by the mobile terminal, the user can further perform a preset operation to close the prompt information, and the mobile terminal can continue to display the page that is currently being displayed.

In actual applications, the payment application can alternatively be started in the background of the mobile terminal, and the user can alternatively be imperceptible. In this way, disturbance to the user can be reduced. For example, if the user is using another application in the mobile terminal, use of the application by the user can be prevented from being interrupted, and disturbance to the user can be reduced.

In one or more embodiments of this specification, a transaction result page can be further displayed, so that the user learns of a payment status. Optionally, the method in one or more embodiments of this specification can further include: obtaining transaction result information fed back by a server; and displaying the transaction result page based on the transaction result information.

The transaction result information can be result information obtained by the server by processing a payment processing request that includes the transaction identification information and that is sent by the payment device, and can be information indicating a transaction success, or can be information indicating a transaction failure. A process in which the server processes the payment processing request can be the same as an existing processing process. Details are omitted here for simplicity.

Similar to the above-mentioned embodiments, in actual applications, before performing payment, the user may be processing another service by using the mobile terminal, for example, is watching a video, playing a game, reading an e-book, reading news, or communicating with another user through instant messaging. In one or more embodiments of this specification, the user can perform payment without a need to exit a current application that is being used before payment. Optionally, in one or more embodiments of this specification, if the mobile terminal is displaying an application page of a second application when obtaining the tag information in the NFC tag, the displaying the transaction result page can specifically include: displaying the transaction result page at an upper layer of the application page of the second application through superimposition.

In actual applications, the transaction result page can be displayed in a partial area or a whole area on the application page of the second application.

Optionally, the method in one or more embodiments of this specification can further include: obtaining an exit operation performed on the transaction result page; and switching to the application page of the second application based on the exit operation for display.

Similar to the transaction result page in the above-mentioned embodiments, the transaction result page in one or more embodiments can include a control used to indicate to exit the page, for example, a confirmation control or a close control. The user can exit the payment page by performing an operation on the control, or can exit the page by performing a preset operation on the page, for example, a sliding operation in a preset direction such as a leftward sliding operation, a rightward sliding operation, an upward sliding operation, or a downward sliding operation. In one or more embodiments of this specification, after the transaction result page is exited, an application page displayed by the mobile terminal before payment can continue to be displayed, to further improve user experience.

In actual applications, if the payment device has a code scanning function, a payment code such as a payment QR code displayed in the mobile terminal can be scanned. In one or more embodiments of this specification, the mobile terminal can alternatively display a payment code page through short-range communication, or can simplify operations that the user opens the payment application and then displays the payment code page. Optionally, the method in one or more embodiments of this specification can further include: generating a payment code image based on the transaction identification information; and displaying the payment code image; and the sending the transaction identification information to a payment device can specifically include: sending the transaction identification information to a payment device with a code scanning function by using the payment code image.

In one or more embodiments of this specification, the payment device can include a device with a code scanning function, for example, a POS terminal, a code scanning box, or a code scanner. In one or more embodiments, the payment identification information can be obtained based on the tag information in the NFC tag, and then the payment code image is generated based on the payment identification information. The payment device can scan the payment code image for payment. The payment identification information can be simply understood as information that is used to perform payment and that is included in an existing payment code, for example, payment QR code digits in the payment QR code. In one or more embodiments of this specification, the generated payment code image can be an image that is the same as or has the same function as the payment code image generated by using a payment QR code control in the mobile terminal, and the payment device can process the payment service based on an existing payment procedure by scanning the code image.

In one or more embodiments of this specification, a payment procedure executed by the payment device after the transaction identification information is obtained can be consistent with an existing payment procedure executed after the transaction identification information is obtained by scanning a code, and service processing can be performed based on the existing procedure, without a need to establish a new processing procedure, to reduce resources, and reduce workload of a developer.

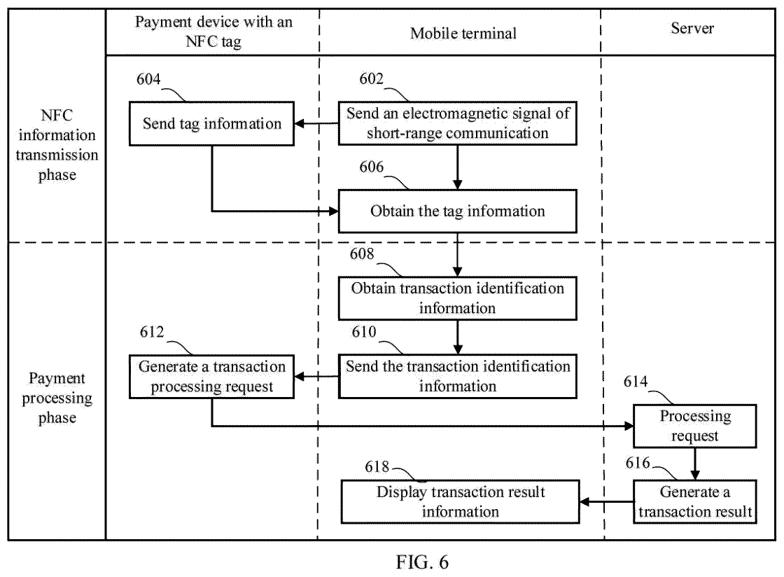

To more clearly describe the payment method based on near field communication provided in the embodiments of this specification, FIG. 6 is a swimlane diagram illustrating a payment method based on near field communication, according to one or more embodiments of this specification. As shown in FIG. 6, the method can include an NFC information transmission phase and a payment processing phase, and can specifically include step 602 to step 618.

Step 602: A mobile terminal with a near field communication function sends an electromagnetic signal used to trigger an NFC tag. An NFC function of the mobile terminal can be enabled to send the electromagnetic signal, to trigger an NFC electronic tag or chip within a preset distance to establish near field communication.

Step 604: When the mobile terminal approaches or abuts the NFC tag, the mobile terminal can establish near field communication with the NFC tag, where the NFC tag can send tag information to the mobile terminal. The tag information can include information used to trigger a payment procedure. Here, that the NFC tag is located in a payment device is used as an example for description. In actual applications, the NFC tag can alternatively be deployed separately from the payment device. This is not specifically limited.

Step 606: The mobile terminal can obtain the tag information in the NFC tag in response to the electromagnetic signal. The tag information can include identification information of a first transaction party, for example, a user ID, a merchant identifier, or merchant authorization information, and can further include information used to start a payment application in the mobile terminal.

Step 608: The mobile terminal obtains, based on the tag information, transaction identification information used to indicate user payment account information in the mobile terminal. The transaction identification information can be generated by a server based on user information of the mobile terminal and fed back to the mobile terminal.

Step 610: Send the transaction identification information to the payment device. A transaction identifier can be sent to the payment device in one or two of the above-mentioned two manners. Step 612: The payment device can generate a transaction processing request based on the transaction identification information, and send the transaction processing request to the server. The transaction processing request can include a payment device identifier or an identifier of a user of the payment device, can further include a transaction amount, and can further include information such as a collection account.

Step 614: The server obtains the transaction processing request sent by the payment device, and can further complete a transaction between transaction parties corresponding to the request. Step 616: The server can further generate a transaction result and feed back the transaction result to the mobile terminal, and can further feed back the transaction result to the payment device. Step 618: The mobile terminal can display transaction result information based on the transaction result fed back by the server. The payment device can further display information indicating the transaction result.

In one or more embodiments, the tag information can alternatively include the payment device identifier or an identifier of a merchant of the payment device, or can verify the payment device based on the identifier, to determine whether the payment device has transaction permission. The transaction identification information can be obtained only when the payment device has the transaction permission. A specific verification process can be the same as or similar to that in the above-mentioned embodiments. Details are omitted here for simplicity.

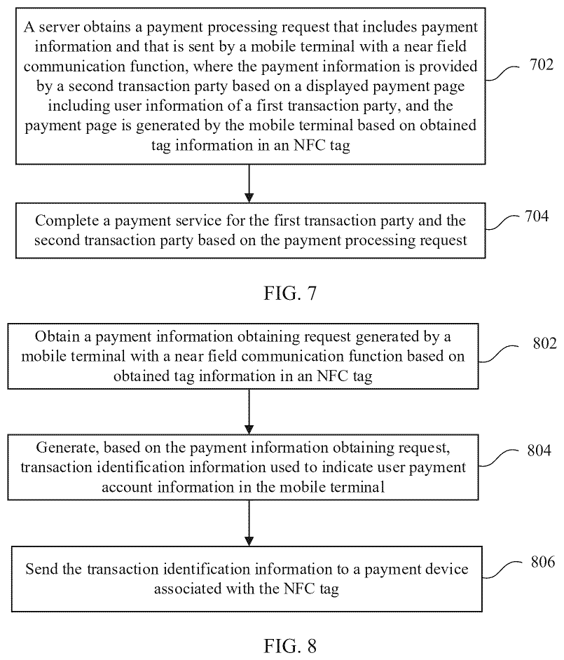

Based on the same idea, FIG. 7 is a schematic flowchart illustrating a near field communication-based payment method, according to one or more embodiments of this specification. As shown in FIG. 7, the solution can include step 702 to step 714.

Step 702: A mobile terminal obtains tag information in an NFC tag associated with a payment device.

The mobile terminal can be a mobile terminal with a near field communication function, and the tag information can include information used to trigger a payment procedure. In actual applications, the mobile terminal can obtain the tag information in the NFC tag by approaching the NFC tag, for example, approaching the payment device with the NFC tag. The NFC tag can be associated with the payment device. For example, the NFC tag can be located in the payment device, or the NFC tag can be deployed separately from the payment device. The payment device can represent a device with a payment processing capability, for example, can be a POS terminal, a container, a cash collection device associated with a cash collection system, or a self-service payment device; or can be another mobile terminal with an NFC function, for example, a mobile phone or a smartwatch. A specific form of the payment device is not specifically limited here. The payment device can also be represented as an NFC device, or a device with an NFC tag or an NFC function.

In this specification, the mobile terminal can serve as a card reader, and always send an LPCD signal when an NFC switch is turned on. Alternatively, LPCD is mixed with active card detection. When the mobile terminal approaches an NFC tag, for example, touches and abuts the payment device, a tag coil in the NFC tag affects the LPCD signal of the mobile terminal in terms of an amplitude or a phase. The mobile terminal can determine, based on such impact, that there is a tag nearby, and then initiate a query to enter an interaction process, which can be specifically command exchange and data exchange. For example, the mobile terminal can obtain the information in the NFC tag. For specific NFC, references can be made to a related technology. Details are omitted here for simplicity.

Step 704: Start a payment application in the mobile terminal based on the tag information.

The tag information can include information used to start the payment application, and specifically, can include an identifier indicating the payment application, for example, a packet name of the payment application. The mobile terminal can start the payment application based on the identifier. In actual applications, an opening system (OS) of the mobile terminal can invoke a corresponding terminal application (app) based on an application package name, and can further provide at least partial information such as at least some URLs in the obtained tag information to the terminal application, so that the terminal application executes a corresponding procedure. For example, the tag information can further include information about a redirection page. After the mobile terminal starts the payment application, the payment application can obtain a URL used to perform page redirection, and the payment application can perform corresponding page redirection based on the URL. For another example, the tag information can further include a service identifier, for example, a payment service. After the payment application is started in the mobile terminal, the payment application can execute a corresponding processing procedure based on the service identifier, for example, send a payment request to the server, or trigger a payment processing procedure of the server, or obtain information fed back by the server.

Step 706: Send a payment processing request to the server based on the started payment application.

That the mobile terminal can send the payment request to the server based on the started payment application can be understood as that the payment application in the mobile terminal sends the payment request to the server. The payment request can include identification information of a payment account used for payment in the mobile terminal. If the tag information includes payment information such as a payment amount, the payment request can also include the payment information such as the payment amount. If the tag information includes information such as a device identifier of the payment device or a transaction party identifier of a party to which the payment device belongs, the payment request can also include the information.

Step 708: The server processes a payment service based on the payment processing request, and feeds back payment result information.

In actual applications, the server can independently process the payment service, or can interact with another device in a processing process to complete the payment service. For a specific implementation process, references can be made to the descriptions in the above-mentioned embodiments. Details are omitted here for simplicity.

Step 710: The mobile terminal can display a transaction result page based on the payment result information fed back by the server.

The transaction result page can also be referred to as a payment result page, and can be a page used to display transaction result information or the payment result information. It can be understood that the one or more embodiments and the above-mentioned embodiments are solutions of the same technical concept. Some specific implementations in the one or more embodiments can be the same as the manners in the above-mentioned embodiments. Details are omitted here for simplicity.

To describe the payment methods provided in the one or more embodiments and the above-mentioned embodiments more clearly, this specification further provides some specific implementations.

To improve user experience and make a user perceive a response made by the mobile terminal, before the payment application is started, the mobile terminal can further display of prompt information.

Optionally, as shown in FIG. 7, step 704 can specifically include: Step 7042: Display a payment prompt page based on the tag information. Step 7044: Obtain a first preset operation performed by the user on the payment prompt page, and generate first confirmation information. Step 7046: Start the payment application in the mobile terminal based on the first confirmation information.

The tag information can include link information used to display the payment prompt page, and the mobile terminal can display the payment prompt page by identifying the link information, or can display the payment prompt page by accessing the link information by using a terminal browser. The payment prompt page can include prompt information used to prompt to use the payment application to perform payment. In actual applications, an operating system of the mobile terminal can display the payment prompt page based on a page identifier or code that corresponds to the payment prompt page and that is included in the link information, or can send, to a server of the mobile terminal, a request used to obtain the payment prompt page, and the server feeds back the payment prompt page.

In one or more embodiments of this specification, the tag information obtained by the mobile terminal can include the information used to start the payment application, and can further include information used to display a page, or information used to request a payment service feedback page of the server.

In an implementation, the tag information can include identification information, for example, an application package name, used to start the payment application, and can further include link information, for example, URL information, used to display a page. After obtaining the application identifier, a system of the mobile terminal can start a corresponding payment application in the mobile terminal, and then provide, to the payment application, the link information used to display a page, and then, the payment application can display the page based on the link information.

In another implementation, the tag information can include the link information, for example, a URL. The link information can include identification information of the payment application, for example, an application package name. The link information URL can further include information used to display a page. For example, the link information includes information used to display the payment prompt page. The mobile terminal can start the payment application based on the link information, open a corresponding page, and display the page. The displaying a payment prompt page based on the tag information can specifically include: displaying the payment prompt page based on the link information.

For example, if the mobile terminal has an iOS system, the mobile terminal can start a corresponding payment application based on the link information in the tag information, and can further display a prompt page prompting the user to use the payment application to perform payment. If the mobile terminal has an Android system, the mobile terminal can start a corresponding payment application based on an application package name in the tag information, and then send, to the payment application, link information that is used to display a page and that is included in the tag information. The payment application can locally generate a display page based on the link information or generate a display page based on the server. In actual applications, a specific format of the tag information can also be set based on an operating system used in the mobile terminal, so that the mobile terminal can accurately identify the tag information. For example, a common tag information format can also be set, so that different operating systems can accurately identify the tag information.

The first preset operation can be a tap operation or a sliding operation, or can be an operation of tilting, turning, or shaking the mobile terminal, etc. The first preset operation can alternatively be a non-substantive operation. For example, the payment prompt page includes a control used to cancel payment. If the user does not operate the control in a preset time period, it can also indicate that the user agrees to use the payment application to perform payment. In other words, after the preset time period, the mobile terminal can generate the first confirmation information. An operation manner is not specifically limited here. The first confirmation information can indicate that the user agrees to use the payment application to perform payment. After the user agrees, the mobile terminal can start the payment application.

FIG. 8 is a schematic diagram illustrating a payment prompt page, according to one or more embodiments of this specification. As shown in FIG. 8, a payment prompt page 800 can include prompt information 802 used to prompt to use a payment application a to perform payment, and can further include a confirmation control 804. If the user taps the confirmation control 804, it can indicate that the user agrees to use the payment application a to perform payment, and the mobile terminal can start the payment application a.

If the payment application a is not installed in the mobile terminal, or the payment application a is installed in the mobile terminal but the user is not registered to use the payment application a, when the user taps the confirmation control 802, a download page used to download a client of the payment application a or a page used to perform registration to use the payment application a can be displayed through redirection, so that after the user is registered in the payment application a, the user can use the payment application a to perform payment.

Optionally, the payment prompt page can further include a “Download” control 806 used to download the client of the payment application a. If the user taps the “Download” control 806, the mobile terminal can redirect to display the download page used to download the client of the payment application a. In actual applications, the mobile terminal can further determine whether the payment application a is installed in the mobile terminal. If the payment application a is installed in the mobile terminal, the payment prompt page does not need to display the “Download” control 806.

The payment prompt page can further include prompt information prompting the user to perform payment through NFC. The payment prompt page can occupy a whole area of the display page of the mobile terminal, or can be located in a partial area on the display page of the mobile terminal, for example, at a location such as a lower part, an upper part, or a middle part; or can be displayed in a collapsible form. FIG. 8 is merely an example. A specific form of the payment prompt page is not limited here.

In this case, the starting the payment application in the mobile terminal in step 7046 can be specifically: The mobile terminal can start the payment application if the user taps the confirmation control on the payment prompt page. It can be understood that, in actual applications, the payment prompt page does not need to be displayed necessarily. For example, the payment prompt page does not need to be displayed on the basis that a payment security need is satisfied or the user has granted authorization.

To improve user experience, in the payment method provided in one or more embodiments of this specification, the mobile terminal can further display a page used by the user to confirm the payment information, so that the user can clearly learn of a payment status. Optionally, as shown in FIG. 7, in one or more embodiments of this specification, before the displaying a transaction result page, the method can further include: step 712: Display a payment page including the payment information. Step 714: Obtain second confirmation information generated based on a second preset operation performed by the user on the payment page.

The payment information can be information related to payment, for example, can include information such as transaction amount information, transaction party information, a transaction manner, or a payment manner. The second preset operation can include a substantive operation performed on the payment page, for example, tapping or sliding a control on the page, or turning or tilting the mobile terminal, and can also include a non-substantive operation performed on the payment page. For example, a control that indicates cancellation of payment on the payment page is not tapped within a preset time period.

The payment information can be included in the NFC tag. For example, a merchant sets, by using the payment device, information about an amount that needs to be paid. For example, a cashier sets an amount in a POS terminal or a checkout counter. Alternatively, an amount can be calculated by using a preset amount calculation program. For example, an automatic payment device or a selling device can determine, by using a computer program, an amount that needs to be transacted, and can set information about the amount in the NFC tag. The tag information obtained by the mobile terminal can include the payment information. The payment information can also be set by a user of the mobile terminal. The tag information can include a page identifier of the payment page. After the payment application is started, the payment application can obtain the payment page from the server based on the page identifier or generate the payment page by using a program of an existing client of the payment application in the mobile terminal.

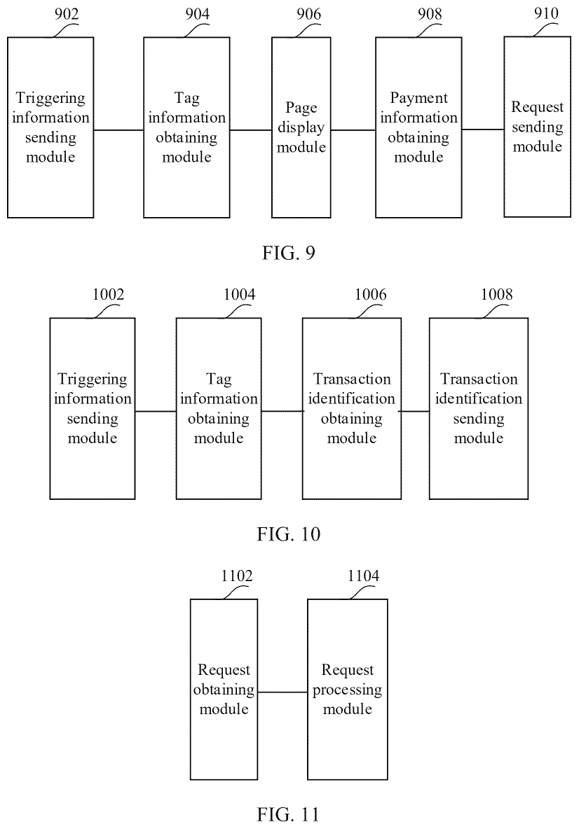

FIG. 9 is a schematic diagram illustrating a payment page, according to one or more embodiments of this specification. As shown in FIG. 9, the payment page can include an area 902 used to display payment information, can specifically display payment amount information, and can further display information such as a payment manner, a transaction party, and a transaction time. The payment page can further include an operation control 904. If the user taps the control, it can indicate that the user agrees to perform payment, and the mobile terminal can generate confirmation information. In actual applications, the operation control can be a control used to confirm payment, or can be a control used to cancel payment. If the user does not tap the control that indicates cancellation of payment within a preset time period, it can also indicate that the user agrees to perform payment, and the mobile terminal can also generate confirmation information, to perform a subsequent procedure. As shown in FIG. 9, the payment page can further include description information 906 for NFC payment, to help the user understand an advantage or a use method of NFC payment.

It can be understood that FIG. 9 is only an example. In actual applications, specific display content and a style of the payment page can be set based on an actual need. Implementations are not specifically limited here. The payment page does not need to be displayed if the user grants authorization or a security need is satisfied.

The second confirmation information can indicate that the user confirms the payment information and agrees to perform payment. In an implementation, the second confirmation information can be used to trigger sending of the payment processing request, and the sending a payment processing request to the server can specifically include: sending the payment processing request to the server based on the second confirmation information.

In one or more embodiments of this specification, the server can generate, based on the payment processing request, transaction identification information used to indicate user payment account information in the mobile terminal, and can further send the transaction identification information to the payment device, so that the payment device executes a payment procedure based on the transaction identification information, to complete payment.

In an implementation, as shown in FIG. 7, step 708 can specifically include: Step 7082: The server generates, based on the payment processing request, the transaction identification information used to indicate the user payment account information in the mobile terminal. Step 7084: Send the transaction identification information to the payment device. Step 7086: The payment device executes the payment procedure based on the obtained transaction identification information.

In actual applications, the server can further perform step 7088: Generate payment result information based on processing information generated by executing the payment procedure by the payment device.

In another implementation, the server can also send the transaction identification information to the mobile terminal, and the mobile terminal sends the transaction identification information to the payment device. Alternatively, the mobile terminal can execute the payment procedure based on the transaction identification information, for example, initiate the payment request to the server, and the payment device does not need to obtain the transaction identification information. For a specific process, references can be made to the content in the above-mentioned embodiments. Details are omitted here for simplicity.

The transaction identification information can be a character string. Specifically, a server configured to process a payment service can recognize the character string, which can be a character string satisfying a payment rule of the payment application, for example, a character string that starts with 28, or a character string that starts with 25, 30, etc. A length of the character string can be 16 bits to 24 bits, or can be another length that satisfies a need. A specific form of the character string is not specifically limited here. For related content of the transaction identification information, references can be made to related descriptions in the above-mentioned embodiments.

The payment device can be a device associated with the server configured to process a payment service. The payment device can send a payment request including the transaction identification information to the server. The server can process the payment request. After processing is completed, the payment device can directly or indirectly send, to the mobile terminal, information indicating that payment ends, and the payment result information can be displayed in the mobile terminal.

The server in this specification can be a server corresponding to the payment application, or can include be a cash collection system with a cash collection function, for example, a system associated with a device such as a checkout counter, a cash collection device, or a self-service payment device disposed in a place such as a supermarket or a shopping mall. In actual applications, the cash collection system can determine, based on the transaction identification information, a user payment account used to perform a transaction. The user payment account can represent a payment account if the cash collection system is used for collection; and the user payment account can represent a collection account if the cash collection system is used for payment. The cash collection system can also correspond to a transaction account. The cash collection system can generate a transaction request based on the obtained user payment account and the transaction account corresponding to the cash collection system, and send the transaction request to the server. The server can process the transaction request. For example, the server can deduct corresponding resources from the user payment account, and add the resources to the transaction account corresponding to the cash collection system. After processing is completed, the server can feed back the payment result information to the server. For a specific transaction processing procedure, references can be made to a related technology. The cash collection system can also process a transaction based on an existing processing procedure. Details are omitted here for simplicity.

In actual applications, an NFC device server used to manage the payment device can also be disposed. The transaction identification information can alternatively be sent by the server to the NFC device server, and then sent by the NFC device server to the payment device. The NFC device server and the above-mentioned server can alternatively be the same server. Implementations are not specifically limited here.

In one or more embodiments of this specification, the payment procedure can be executed based on the payment device. In an implementation, after the payment application is started, the mobile terminal can send the payment processing request to the server based on the started payment application, and the server can process the payment processing request, generate the transaction identification information, and send the transaction identification information to the payment device. The second confirmation information generated based on the payment page can also be used as a trigger signal for triggering the payment device to execute the payment procedure based on the transaction identification information. Optionally, in this specification, after the starting the payment application in the mobile terminal, the method can further include: displaying the payment page including the payment information; obtaining the second confirmation information generated based on the second preset operation performed by the user on the payment page, so that the server sends a payment procedure trigger instruction to the payment device after the second confirmation information is obtained, and the payment device is capable of executing the payment procedure based on the payment procedure trigger instruction and the obtained transaction identification information.

After obtaining the second confirmation information, the mobile terminal can send, to the server, corresponding information indicating that the user confirms payment. The server can further send the payment procedure trigger instruction to the payment device. After receiving the payment procedure trigger instruction, the payment device is capable of executing the payment procedure based on the obtained transaction identification information.

In one or more embodiments of this specification, after the payment processing request is started, the mobile terminal can send the payment processing request to the server, and the server can generate the transaction identification information, and send the transaction identification information to the payment device. When the mobile terminal displays the payment page, the server can generate the transaction identification information, and can further send the transaction identification information to the payment device, so that before the user performs a preset operation on the payment page, the payment device can obtain the transaction identification information, and the payment device can temporarily store the transaction identification information. After the user performs the preset operation on the payment page, the payment device can execute the payment procedure based on the obtained transaction identification information, without a need to wait for the server to send the transaction identification information, to improve payment efficiency.

Optionally, in one or more embodiments of this specification, before the displaying the payment page including the payment information, the method can further include: determining, based on account information of the payment application in the mobile terminal, whether a user of the mobile terminal satisfies a preset payment condition. The preset payment condition represents a condition under which quick payment is capable of being performed. The displaying the payment page including the payment information can specifically include: displaying the payment page including the payment information if the user does not satisfy the preset payment condition.

Quick payment can represent a payment manner in which there are a relatively small quantity of operation steps of the user, or a payment manner in which the user does not need to perform an operation. For example, in the content described in the above-mentioned embodiments, the mobile terminal can complete payment by using the NFC function, and display the transaction result page. In a whole payment process, the user does not need to perform cumbersome operations.

If the user does not satisfy the preset payment condition, that is, quick payment cannot be performed, the payment page can be displayed to the user, so that the user confirms payment information. The transaction result page can be displayed if the user satisfies the preset payment condition. That is, the mobile terminal does not need to display the payment page before displaying the transaction result page.

In one or more embodiments of this specification, whether the user satisfies the preset payment condition can be determined based on a user feature. Optionally, the preset payment condition includes at least one of the following: use of an instant payment function is authorized, the user is a highly active user who uses the payment application, and use of a password-free payment function is authorized.

The instant payment function can represent a confirmation-free payment function. For example, the above-described pages such as the payment page and/or the payment prompt page do not need to be displayed before the transaction result page, and a related operation that the user confirms payment does not need to be performed or is reduced. This is an extremely quick payment manner. In actual applications, the user can enable the instant payment function on a related setting page of the payment application. If the user has granted authorization to use the instant payment function, it can be determined that the user satisfies the preset payment condition. When the user performs payment through NFC, the payment page does not need to be displayed, or the payment prompt page does not need to be displayed; instead, the transaction result page can be directly displayed.

The highly active user can represent a user whose degree of activity of using the payment application is greater than or equal to a preset threshold. In actual applications, a degree of activity of the user can be calculated based on factors such as duration and a frequency of logging in to the payment application by the user. The degree of activity of the user can alternatively be determined based on a frequency at which the user uses the payment application to perform code scanning payment or output a payment code. A quick payment processing procedure can be provided for the highly active user. For example, the payment page does not need to be displayed.

In actual applications, for the highly active user, in the payment application of the user, the instant payment function can also be in a default enabled state, and a corresponding payment procedure can be provided for the user based on a state of the instant payment function. The password-free payment function can represent a function of performing payment without entering a password, and payment can be performed by using biological features such as a fingerprint, a face, a voiceprint, and an iris as verification information.

In an implementation, if the mobile terminal has an iOS system, after the mobile terminal approaches the NFC tag and obtains the tag information, the mobile terminal can display the payment prompt page. The payment prompt page can be displayed in a form of a Clips card. If the payment prompt page includes a control used to indicate to confirm to start the payment application, the user can operate the control. As shown in FIG. 8, when the user taps an “Open” control, it can indicate that the user agrees to use the payment application to perform payment, and the mobile terminal can start the payment application. The mobile terminal can send the payment processing request to the server based on the started payment application, the server can process the payment service and return result information, and the mobile terminal can display the transaction result page. In actual applications, in a process in which the user performs an operation on the payment prompt page, the mobile terminal can collect biometric feature information of the user as payment verification information. If the user submits, based on the payment prompt page, information indicating confirmation, it can also indicate that the user confirms the payment information and the payment page does not need to be displayed. Certainly, the payment page can also be displayed based on an actual need.

In an implementation, if the mobile terminal has an Android system, after the mobile terminal approaches the NFC tag and obtains the tag information, if the payment application is installed in the mobile terminal, the payment application can be started, and the payment page is displayed. After the user confirms the information on the payment page, the transaction result page can be displayed. If the user has enabled the instant payment function, after the payment application is started, the payment page does not need to be displayed. After obtaining the payment result information, the mobile terminal can display the transaction result page. From a user use perspective, after the user uses the mobile terminal to approach the NFC tag or the payment device, the mobile terminal can start the payment application and display the payment page. To improve user experience, a payment response page indicating that payment is being performed can be further displayed after the payment application is started, and then the transaction result page is displayed. If the user does not enable the instant payment function, the payment page can be displayed after the payment application is started, and then the transaction result page is displayed. Similarly, the payment response page can be displayed before or after the payment page is displayed, and then the transaction result page is displayed.

To improve user experience, optionally, the method in one or more embodiments of this specification can further include: displaying prompt information used to prompt the user to set the instant payment function.

Specifically, the prompt information can be information prompting the user to enable the instant payment function, or can be information prompting the user to disable the instant payment function. The prompt information can be displayed after the payment application is started, and can be displayed on a payment related page such as the payment page or the transaction result page displayed in the payment procedure, or can be independently displayed. For example, after the payment application is started and before the payment page is displayed, a page that includes the prompt information used to prompt the user to set the instant payment function can be displayed. For another example, after the payment page is displayed, a page that includes the prompt information used to prompt the user to set the instant payment function can be displayed. For another example, after the transaction result page is displayed, a page that includes the prompt information used to prompt the user to set the instant payment function is displayed. A display manner of the prompt information is not specifically limited.

To avoid excessively disturbing the user, the method in one or more embodiments of this specification can further include: determining whether a quantity of times of displaying the prompt information used to prompt the user to set the instant payment function is less than or equal to a preset quantity of times in a preset time period; and if the quantity of times of displaying the prompt information is less than or equal to the preset quantity of times, displaying the prompt information used to prompt the user to set the instant payment function.

The preset time period and the preset quantity of times can be set based on an actual need. For example, the prompt information can be displayed for at least one time in one day and a maximum of four times. For another example, the prompt information can be displayed for the first transaction in one day, and then displayed every five transactions. For another example, the prompt information can be displayed for eight times in one week.

Optionally, the method in one or more embodiments of this specification can further include: determining whether the instant payment function is enabled for a user account of the payment application in the mobile terminal; and the displaying prompt information used to prompt a user to set an instant payment function specifically includes: if the instant payment function is not enabled for the user account, displaying first prompt information used to prompt the user to enable the instant payment function.

In one or more embodiments of this specification, if the user does not enable the instant payment function, the first prompt information used to prompt the user to enable the instant payment function can be displayed in the mobile terminal. If the user has enabled the instant payment function, the first prompt information used to prompt the user to enable the instant payment function does not need to be displayed, to reduce disturbance to the user.

To further improve user experience, optionally, before the displaying first prompt information used to prompt the user to enable the instant payment function, the method can further include: determining whether the user account is a highly active user account, where the displaying first prompt information used to prompt the user to enable the instant payment function specifically includes: if the user account is a highly active user account, displaying the first prompt information used to prompt the user to enable the instant payment function.

The highly active user account can represent a highly active user account. In one or more embodiments of this specification, the first prompt information used to prompt the user to enable the instant payment function can be displayed for the highly active user account, so that the first prompt information can be provided to a user who has an actual need for the function.

Optionally, the displaying prompt information used to prompt a user to set an instant payment function further specifically includes: if the instant payment function is started for the user account, displaying second prompt information used to prompt the user to disable the instant payment function.

In one or more embodiments of this specification, if the user has enabled the instant payment function, the second prompt information used to prompt the user to disable the instant payment function can be displayed in the mobile terminal. If the user does not enable the instant payment function, the second prompt information does not need to be displayed in the mobile terminal.

In actual applications, before the second prompt information is displayed, whether the user account is a highly active user account can be further determined. If the user account is not a highly active user account, the second prompt information can be displayed, to avoid disturbance to the user.

In an implementation, in one or more embodiments of this specification, the prompt information used to prompt the user to set the instant payment function can be displayed on the transaction result page or at an upper layer.

FIG. 10 is a schematic diagram illustrating a transaction result page, according to one or more embodiments of this specification. As shown in FIG. 10, the transaction result page can include payment result information 1002, for example, a payment success or a payment failure; can further include payment information 1004, for example, a payment amount, a payment manner, a transaction party, or discount information; and can further include a control 1006 such as a “Done” control used to close the transaction result page. In actual applications, specific content and a specific format of the transaction result page can be set based on an actual need. Implementations are not specifically limited here.

FIG. 11 is a schematic diagram illustrating display of prompt information, according to one or more embodiments of this specification. As shown in FIG. 11, prompt information 1102 used to prompt the user to set the instant payment function can be displayed at the upper layer of the transaction result page in form of a pop-up window. Specific content of the prompt information can be set based on an actual need. For example, the prompt information can further include path information used to set the instant payment function.

As shown in FIG. 11, a page on which the prompt information is located can further include an operation control 1104 used to set the instant payment function. The control can be used to enable or disable the instant payment function, or a setting page used to set the instant payment function can be displayed through redirection. The page can further include a control used to close the page.

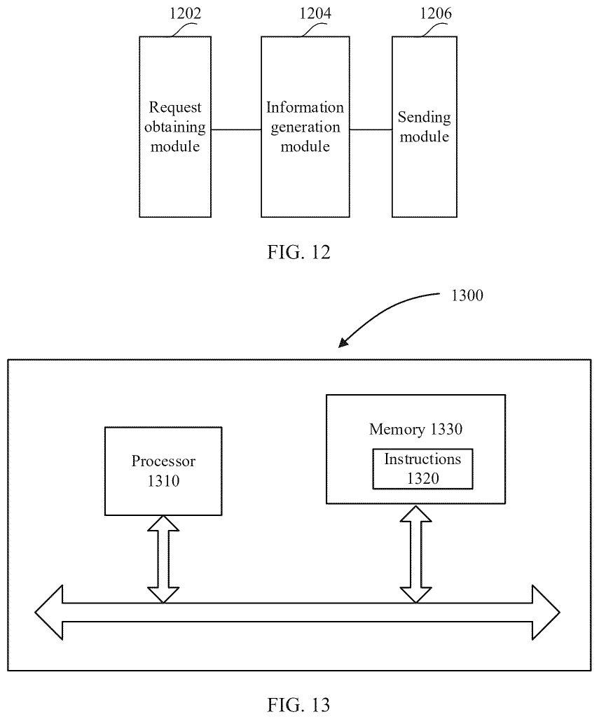

FIG. 12 is a schematic diagram illustrating display of prompt information, according to one or more embodiments of this specification. As shown in FIG. 12, prompt information 1202 used to prompt the user to set the instant payment function can be displayed on the transaction result page. The page can further include an operation control 1204 used to set the instant payment function. The prompt information can also coincide with or not coincide with a display area of the operation control.

In actual applications, for one initiated transaction request, the prompt information is displayed in a form displayed on the transaction result page or in any one of forms displayed on the upper layer of the payment page, or can be displayed in the above-mentioned two forms. For example, if the user taps a close control in the pop-up window shown in FIG. 11, a transaction result page on which prompt information is displayed as shown in FIG. 12 can be displayed. In actual applications, the prompt information and a specific control name, form, layout, etc. of the operation control can be set based on an actual need.

FIG. 13 is a schematic diagram illustrating display of prompt information, according to one or more embodiments of this specification. As shown in FIG. 13, prompt information 1302 used to prompt the user to set the instant payment function can be displayed on the transaction result page. The page can further include an operation control 1304 used to set the instant payment function.

In actual applications, the prompt information can alternatively be displayed in different manners for different users. For example, for a user whose does not enable the instant payment function, the prompt information can be displayed in a manner shown in FIG. 11, and for a user whose enables the instant payment function, the prompt information can be displayed in a manner shown in FIG. 13.

If the user performs an operation on an operation control on a page on which the prompt information is displayed, the mobile terminal can further display a setting page used to set the instant payment function.

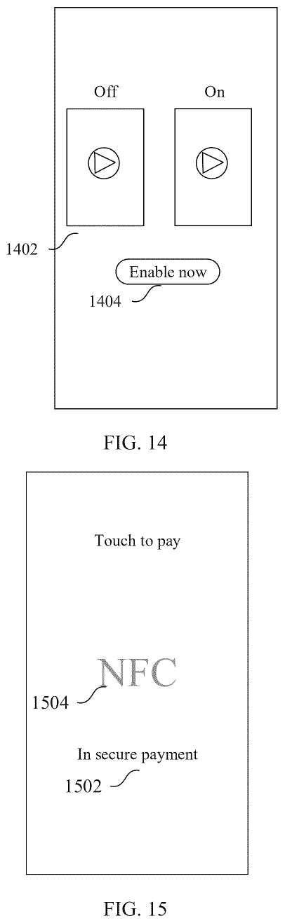

FIG. 14 is a schematic diagram illustrating a setting page, according to one or more embodiments of this specification. As shown in FIG. 14, the page can include related description information 1402 of the instant payment function, and can be information in a form such as a text, a video, or a voice. For example, the page can include video presentation information before and after the instant payment function is enabled, so that if the user has enabled the instant payment function, a control 1404 on the setting page can be used to disable the function. If the user has not enabled the function, the control 1404 on the setting page can be used to enable the function. In actual applications, after the user completes setting of the instant payment function, the mobile terminal can further display the transaction result page.

In consideration that the mobile terminal or the server also needs some time to execute the payment procedure, and to improve user experience, optionally, in one or more embodiments of this specification, before the displaying a transaction result page, the method can further include: displaying a payment response page, where the payment response page includes prompt information indicating that payment is being performed.

FIG. 15 is a schematic diagram illustrating a payment response page, according to one or more embodiments of this specification. As shown in FIG. 15, the payment response page can include prompt information 1502 indicating that payment is being performed; can further include information 1504 such as an “NFC” word indicating that a near field communication manner is used; and can further include related description information, etc. of near field communication, for example, a word “Touch to pay” shown in FIG. 15.

It can be understood that each schematic diagram provided in this specification is merely an example. In actual applications, display content, a style, etc. of each page can be set based on an actual need.

After starting the payment application, the mobile terminal can display the payment response page. After the server completes processing of the payment procedure, the mobile terminal can display the transaction result page.

In an implementation, after the user uses the mobile terminal in which the instant payment function is enabled to approach the payment device with the NFC tag, the payment response page can be displayed in the mobile terminal.

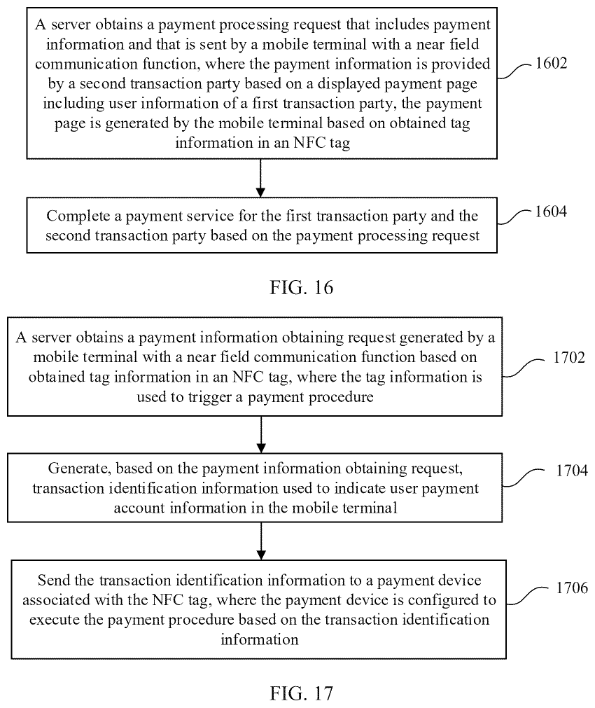

In one or more embodiments of this specification, the payment prompt page, the payment page, or the transaction result page can be displayed the mobile terminal in an unlocked state, or can be displayed in a locked state. For example, after the mobile terminal obtains, in a lock screen state, the tag information in the NFC tag, the payment prompt page can be displayed. In a process in which the user performs an operation on the payment prompt page, a camera of the mobile terminal can collect biological feature images such as a face, an iris, and a fingerprint of the user, and unlock the mobile terminal. The mobile terminal can display the transaction result page in the unlocked state. In actual applications, the user can unlock the mobile terminal, and then move the mobile terminal to approach the NFC tag to obtain the tag information. For example, when a distance between the mobile terminal and the NFC tag satisfies a condition, for example, in a process in which the mobile terminal approaches the NFC tag, the mobile terminal or the payment device associated with the NFC tag can send prompt information used to prompt the user to unlock the mobile terminal, for example, voice prompt information, text prompt information, or animation prompt information. To simplify user operations, the application can be started in the background in the locked state, and the payment prompt page, the payment page, or the transaction result page is displayed. Based on the same idea, one or more embodiments of this specification further provide a near field communication-based payment method performed by a server. FIG. 16 is a schematic flowchart illustrating a near field communication-based payment method, according to one or more embodiments this specification. From a program perspective, a procedure can be performed by a program or an application client integrated with a server.

As shown in FIG. 16, the procedure can include the following steps: Step 1602: The server obtains a payment processing request that is sent by a mobile terminal with a near field communication function and that includes payment information, where the payment information is provided by a second transaction party based on a displayed payment page that includes user information of a first transaction party, the payment page is generated by the mobile terminal based on obtained tag information in an NFC tag, and the tag information includes payment link information. Step 1604: Complete a payment service for the first transaction party and the second transaction party based on the payment processing request.

The server can be a server with a payment processing capability, and can determine a transaction account or account of the first transaction party based on the user information of the first transaction party, such as a merchant identifier or a user identifier, or can determine a transaction amount and a transaction account or account of the second transaction party based on transaction information provided by the second transaction party, to complete processing of a transaction of the transaction amount. The server in the one or more embodiments can be equivalent to the server in the method described in FIG. 2. For the similar or same parts, references can be made to the content described in the above-mentioned embodiments. Details are omitted here for simplicity.

FIG. 17 is a schematic flowchart illustrating a near field communication-based payment method, according to one or more embodiments of this specification. From a program perspective, a procedure can be performed by a program or an application client integrated with a server.

As shown in FIG. 17, the procedure can include the following steps: Step 1702: The server obtains a payment information obtaining request generated by a mobile terminal with a near field communication function based on obtained tag information in an NFC tag, where the tag information is used to trigger a payment procedure. Step 1704: Generate, based on the payment information obtaining request, transaction identification information used to indicate user payment account information in the mobile terminal. Step 1706: Send the transaction identification information to a payment device associated with the NFC tag, where the payment device is configured to perform the payment procedure based on the transaction identification information.

The server can be equivalent to the server in the method described in FIG. 5. For specific content described here, references can be made to the content described in the above-mentioned embodiments. Details are omitted here for simplicity. The server in the one or more embodiments can also be the same as the server in FIG. 2 or FIG. 16. Implementations are not specifically limited here.

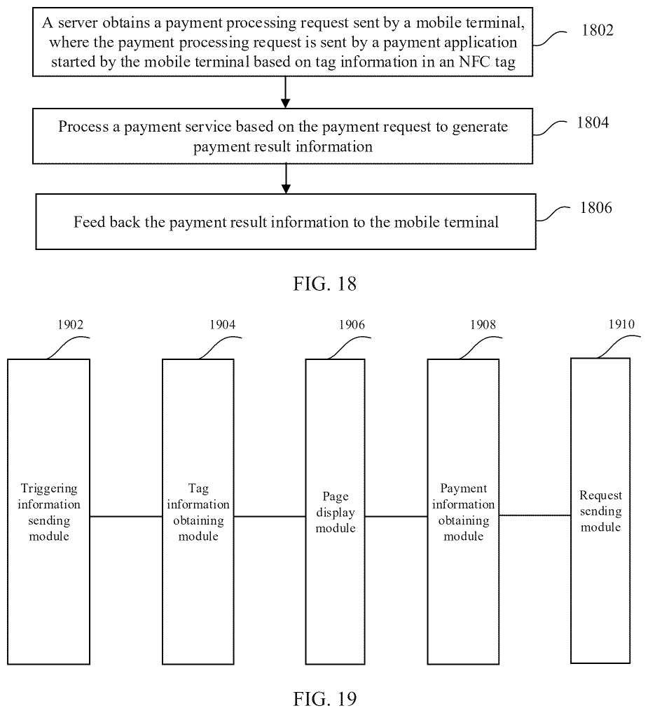

FIG. 18 is a schematic flowchart illustrating a near field communication-based payment method, according to one or more embodiments of this specification. From a program perspective, a procedure can be performed by a program or an application client integrated with a server.

As shown in FIG. 18, the procedure can include the following steps: Step 1802: The server obtains a payment processing request sent by a mobile terminal, where the payment processing request is sent by a payment application enabled by the mobile terminal based on tag information in an NFC tag. Step 1804: Process a payment service based on the payment request to generate payment result information. Step 1806: Feed back the payment result information to the mobile terminal.

Optionally, the processing a payment service based on the payment request can specifically include: generating, based on the payment processing request, transaction identification information used to indicate user payment account information in the mobile terminal; and sending the transaction identification information to a payment device, so that the payment device performs a payment procedure based on the transaction identification information.

Optionally, the method can further include: sending a payment procedure trigger instruction to the payment device, so that the payment device can perform the payment procedure based on the obtained transaction identification information based on the payment procedure trigger instruction.

For a specific implementation process, references can be made to the content in the above-mentioned embodiments. Details are omitted here for simplicity.

In one or more embodiments of this specification, information transmission between the payment device, the mobile terminal, and the server can be transmitted through a network.

Based on the same idea, an embodiment of this specification further provides an apparatus corresponding to the above-mentioned method. FIG. 19 is a schematic diagram illustrating a structure of a near field communication-based payment apparatus corresponding to FIG. 2, according to one or more embodiments of this specification. As shown in FIG. 19, the apparatus can include: a triggering information sending module 1902, configured to send an electromagnetic signal used to trigger an NFC tag; a tag information obtaining module 1904, configured to obtain tag information of the NFC tag that responds to the electromagnetic signal, where the tag information includes payment link information; a page display module 1906, configured to display, based on the payment link information, a payment page that includes user information of a first transaction party; a payment information obtaining module 1908, configured to obtain payment information provided by a second transaction party based on the payment page; and a request sending module 1910, configured to send a payment processing request that includes the payment information to a server, where the server is configured to complete payment based on the payment processing request.

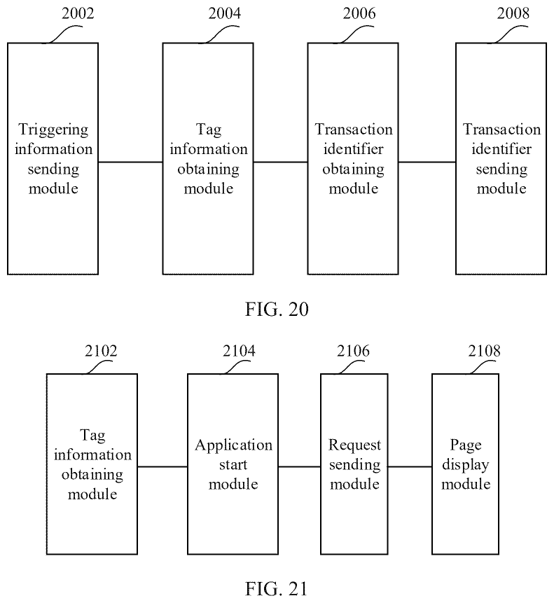

Based on the same idea, an embodiment of this specification further provides an apparatus corresponding to the above-mentioned method. FIG. 20 is a schematic diagram illustrating a structure of a near field communication-based payment apparatus corresponding to FIG. 5, according to one or more embodiments of this specification. As shown in FIG. 20, the apparatus can include: a triggering information sending module 2002, configured to send an electromagnetic signal used to trigger an NFC tag; a tag information obtaining module 2004, configured to obtain tag information of the NFC tag that responds to the electromagnetic signal, where the tag information is used to trigger a payment procedure; a transaction identifier obtaining module 2006, configured to obtain, based on the tag information, transaction identification information used to indicate user payment account information in the mobile terminal; and a transaction identifier sending module 2008, configured to send the transaction identification information to a payment device associated with the NFC tag, where the payment device is configured to perform the payment procedure based on the transaction identification information.

FIG. 21 is a schematic diagram illustrating a structure of a near field communication-based payment apparatus corresponding to FIG. 7, according to one or more embodiments of this specification. As shown in FIG. 21, the apparatus can include: a tag information obtaining module 2102, configured to obtain tag information of an NFC tag associated with a payment device; an application start module 2104, configured to enable a payment application in the mobile terminal based on the tag information; a request sending module 2106, configured to send a payment processing request to a server based on the enabled payment application, where the server is configured to process a payment service based on the payment processing request and feed back payment result information; and a page display module 2108, configured to display a transaction result page based on the payment result information fed back by the server.

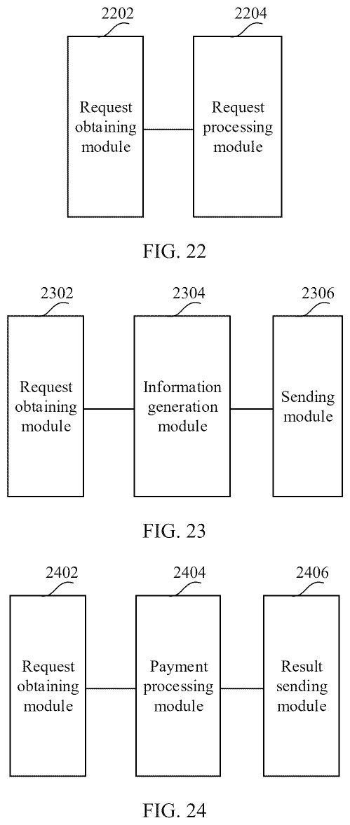

FIG. 22 is a schematic diagram illustrating a structure of a near field communication-based payment apparatus corresponding to FIG. 16, according to one or more embodiments of this specification. As shown in FIG. 22, the apparatus can include: a request obtaining module 2202, configured to obtain a payment processing request that is sent by a mobile terminal with a near field communication function and that includes payment information, where the payment information is provided by a second transaction party based on a displayed payment page that includes user information of a first transaction party, the payment page is generated by the mobile terminal based on obtained tag information in an NFC tag, and the tag information includes payment link information; and a request processing module 2204, configured to complete a payment service for the first transaction party and the second transaction party based on the payment processing request.

FIG. 23 is a schematic diagram illustrating a structure of a near field communication-based payment apparatus corresponding to FIG. 17, according to one or more embodiments of this specification. As shown in FIG. 23, the apparatus can include: a request obtaining module 2302, configured to obtain a payment information obtaining request generated by a mobile terminal with a near field communication function based on obtained tag information in an NFC tag, where the tag information is used to trigger a payment procedure; an information generation module 2304, configured to generate, based on the payment information obtaining request, transaction identification information used to indicate user payment account information in the mobile terminal; and a sending module 2306, configured to send the transaction identification information to a payment device associated with the NFC tag, where the payment device is configured to execute the payment procedure based on the transaction identification information.

FIG. 24 is a schematic diagram illustrating a structure of a near field communication-based payment apparatus corresponding to FIG. 18, according to one or more embodiments of this specification. As shown in FIG. 24, the apparatus can include: a request obtaining module 2402, configured to obtain a payment processing request sent by a mobile terminal, where the payment processing request is sent by a payment application started by the mobile terminal based on tag information in an NFC tag; a payment processing module 2404, configured to process a payment service based on the payment request to generate payment result information; and a result sending module 2406, configured to feed back the payment result information to the mobile terminal.

Based on the same idea, an embodiment of this specification further provides a device corresponding to the above-mentioned method.

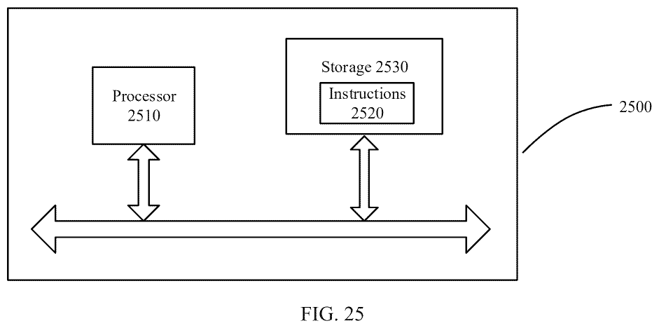

FIG. 25 is a schematic diagram illustrating a structure of a payment device based on near field communication according to one or more embodiments of this specification. As shown in FIG. 25, the device 2500 can include: at least one processor 2510, and a storage 2530 communicatively connected to the at least one processor. The storage 2530 stores instructions 2520 executable by the at least one processor 2510, and the instructions are executed by the at least one processor 2510, so that the at least one processor 2510 is capable of performing at least one of the above-mentioned near field communication-based payment methods.

Based on the same idea, an embodiment of this specification further provides a computer-readable medium corresponding to the above-mentioned method. The computer-readable medium stores computer-readable instructions, and the computer-readable instructions can be executed by a processor to implement at least one of the above-mentioned near field communication-based payment methods.

The embodiments of this specification are described in a progressive way. For same or similar parts of the embodiments, mutual references can be made to the embodiments. Each embodiment focuses on a difference from other embodiments. In particular, the apparatuses and the devices are basically similar to the method embodiments, and therefore are described briefly. For related parts, references can be made to partial descriptions in the method embodiments.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer independently performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

The controller can be implemented in any suitable manner. For example, the controller can take the form of a computer-readable medium, a logic gate, a switch, an application specific integrated circuit (ASIC), a programmable logic controller, and an embedded microcontroller that store computer-readable program code (such as software or firmware) executable by a microprocessor or a processor. Examples of the controller include but are not limited to the following microcontrollers: ARC 625D, Atmel AT91SAM, Microchip PIC18F26K20, and Silicone Labs C8051F320. The memory controller can also be implemented as part of the control logic of the memory. A person skilled in the art also knows that, in addition to implementing the controller in a pure computer-readable program code manner, a method step can be logically programmed, so that the controller implements a same function in a form of a logic gate, a switch, an application-specific integrated circuit, a programmable logic controller, an embedded microcontroller, etc. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that an embodiment of this specification can be provided as a method, a system, or a computer program product. Therefore, this specification can use a form of hardware only embodiments, software only embodiments, or embodiments with a combination of software and hardware. Moreover, a form of a computer program product that is implemented on one or more computer-usable storage media (including but not limited to a disk memory, a CD-ROM, an optical memory, etc.) that include computer-usable program code can be used in this specification.

This specification is described with reference to the flowcharts and/or block diagrams of the method, the device (system), and the computer program product based on the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can also be stored in a computer-readable memory that can instruct a computer or another programmable data processing device to work in a specific manner, so that an instruction stored in the computer-readable memory generates a manufacturer including an instruction apparatus, and the instruction apparatus implements a function specified in one or more procedures of a flowchart and/or one or more blocks of a block diagram.

The computer program instructions can alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory. The memory can include a non-persistent storage, a random access memory (RAM), and/or a nonvolatile memory in a computer-readable medium, for example, a read-only memory (ROM) or a flash read-only memory (flash RAM). The memory is an example of the computer-readable medium.

The computer-readable medium includes a persistent and a non-persistent, a removable and a non-removable medium, which implement information storage by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by the computing device. Based on the definition in the present specification, the computer-readable medium does not include transitory media such as a modulated data signal and carrier.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of this specification can be provided as methods, systems, or computer program products. Therefore, this specification can use a form of hardware only embodiments, software only embodiments, or embodiments with a combination of software and hardware. In addition, a form of a computer program product that is implemented on one or more computer-usable storage media (including but not limited to a disk memory, a CD-ROM, an optical memory, etc.) that include computer-usable program code can be used in this specification.

This specification can be described in the general context of computer-executable instructions, for example, a program module. Generally, the program module includes a routine, a program, an object, a component, a data structure, etc. executing a specific task or implementing a specific abstract data type. This specification can alternatively be practiced in distributed computing environments. In the distributed computing environments, tasks are executed by remote processing devices connected through a communication network. In the distributed computing environments, the program module can be located in both local and remote computer storage media including storage devices.

The above-mentioned descriptions are merely embodiments of this specification, and are not intended to limit this specification. A person skilled in the art can make various modifications and changes to this specification. Any modification, equivalent replacement, or improvement made without departing from the spirit and principle of this specification shall fall within the scope of the claims in this specification.

What is claimed is:

1. A payment method based on near field communication, comprising:
sending, by a mobile terminal with a near field communication function, an electromagnetic signal used to trigger an NFC tag;
obtaining tag information in the NFC tag in response to the electromagnetic signal, wherein the tag information comprises payment link information;
displaying, based on the payment link information, a payment page comprising user information of a first transaction party;
obtaining payment information provided by a second transaction party based on the payment page; and
sending a payment processing request comprising the payment information to a server, wherein the server is configured to complete payment based on the payment processing request.

2. The method according to claim 1, wherein the tag information comprises instruction information used to start a payment application; and
the displaying, based on the payment link information, a payment page comprising user information of a first transaction party specifically comprises:
starting the payment application in the mobile terminal based on the instruction information; and
displaying the payment page based on the started payment application.

3. The method according to claim 2, wherein the tag information comprises request identification information used to request to obtain payment page information, and the displaying the payment page based on the started payment application specifically comprises:
generating, by the payment application in a started state, a payment page information obtaining request based on the request identification information;
sending the payment page obtaining request to the server;
obtaining payment page information that is generated by the server based on the payment page obtaining request and that comprises the user information of the first transaction party; and
displaying, based on the payment page information, the payment page comprising the user information of the first transaction party.

4. The method according to claim 1, wherein the tag information comprises user identification information of the first transaction party, and the method further comprises:
determining, based on the user identification information, whether the first transaction party has transaction permission, to obtain a determining result; and
the displaying a payment page comprising user information of a first transaction party specifically comprises:
if the determining result indicates that the first transaction party has the transaction permission, displaying the payment page comprising the user information of the first transaction party.

5. The method according to claim 1, wherein the NFC tag is located in a carrier comprising a payment code of the first transaction party, or is located in a carrier that does not comprise a payment code of the first transaction party.

6. The method according to claim 1, wherein if the mobile terminal is displaying an application page of a second application when the tag information that is in the NFC tag and that comprises the payment link information is obtained, the displaying a payment page comprising user information of a first transaction party specifically comprises:
displaying the payment page at an upper layer of the application page of the second application through superimposition.

7. The method according to claim 1, wherein the tag information comprises first triggering information, the first triggering information is used to trigger the mobile terminal to determine a terminal application with a payment function in the mobile terminal and generate an application selection page, and the method further comprises:
determining, in response to the first triggering information, the terminal application with the payment function in the mobile terminal;
generating the application selection page based on the terminal application with the payment function; and
displaying the application selection page.

8. The method according to claim 7, wherein after the displaying the application selection page, the method further comprises:
obtaining a target terminal application selected by the second transaction party from the application selection page; and
the displaying, based on the payment link information, a payment page comprising user information of a first transaction party specifically comprises:
accessing the payment link information by using the target terminal application; and
displaying, in the target terminal application, the payment page comprising the user information of the first transaction party.

9. The method according to claim 1, wherein before the obtaining tag information in the NFC tag in response to the electromagnetic signal, the method comprises:
determining whether the mobile terminal has started a code scanning application used to scan a payment code image; and
the obtaining tag information in the NFC tag in response to the electromagnetic signal specifically comprises:
obtaining the tag information in the NFC tag in response to the electromagnetic signal if the mobile terminal does not start the code scanning application used to scan the payment code image.

10. The method according to claim 1, wherein the payment page comprises at least one of a control used to confirm payment information, an area used to fill in or select a payment amount, or an area used to fill in or select a payment manner.

11. The method according to claim 2, wherein the method further comprises:
determining whether the payment application exists in the mobile terminal; and
if the payment application does not exist in the mobile terminal, generating prompt information indicating that payment cannot be performed, or prompting a user to download and install the payment application.

12. A payment method based on near field communication, comprising:
obtaining, by a mobile terminal with a near field communication function, tag information in an NFC tag associated with a payment device;
starting a payment application in the mobile terminal based on the tag information;
sending a payment processing request to a server based on the started payment application, wherein the server is configured to: process a payment service based on the payment processing request, and feed back payment result information; and
displaying a transaction result page based on the payment result information fed back by the server.

13. The method according to claim 12, wherein the method further comprises:
displaying a payment prompt page based on the tag information, wherein the payment prompt page comprises prompt information used to prompt to use the payment application to perform payment; and
obtaining a first preset operation performed by a user on the payment prompt page, and generating first confirmation information; and
the starting a payment application in the mobile terminal specifically comprises:
starting the payment application in the mobile terminal based on the first confirmation information.

14. The method according to claim 12, before the displaying a transaction result page, further comprising:
displaying a payment page comprising payment information; and
obtaining second confirmation information generated based on a second preset operation performed by a user on the payment page, wherein the sending a payment processing request to a server specifically comprises:
sending the payment processing request to the server based on the second confirmation information.

15. The method according to claim 12, wherein the server is configured to: generate, based on the payment processing request, transaction identification information used to indicate user payment account information in the mobile terminal, and send the transaction identification information to the payment device, so that the payment device executes a payment procedure based on the transaction identification information.

16. The method according to claim 15, after the starting a payment application in the mobile terminal, further comprising:
displaying a payment page comprising payment information; and
obtaining second confirmation information generated based on a second preset operation performed by a user on the payment page, so that the server sends a payment procedure trigger instruction to the payment device after the second confirmation information is obtained, and the payment device is capable of executing the payment procedure based on the payment procedure trigger instruction and the obtained transaction identification information.

17. The method according to claim 14, before the displaying a payment page comprising payment information, further comprising:
determining, based on account information of the payment application in the mobile terminal, whether a user of the mobile terminal satisfies a preset payment condition, wherein the preset payment condition represents a condition under which quick payment is capable of being performed, wherein
the displaying a payment page comprising payment information specifically comprises:
displaying the payment page comprising the payment information if the user does not satisfy the preset payment condition.

18. The method according to claim 17, wherein the displaying a transaction result page specifically comprises:
displaying the transaction result page if the user satisfies the preset payment condition.

19. The method according to claim 17, wherein the preset payment condition comprises at least one of the following: use of an instant payment function is authorized, the user is a highly active user who uses the payment application, and use of a password-free payment function is authorized.

20. The method according to claim 14, wherein the payment information comprises at least one of transaction amount information, transaction party information, or transaction manner information.

21. The method according to claim 14, wherein the method further comprises:
displaying prompt information used to prompt a user to set an instant payment function.

22. The method according to claim 21, wherein the method further comprises:
determining whether a quantity of times of displaying the prompt information used to prompt the user to set the instant payment function is less than or equal to a preset quantity of times in a preset time period; and
the displaying prompt information used to prompt a user to set an instant payment function specifically comprises:
if the quantity of times of displaying the prompt information is less than or equal to the preset quantity of times, displaying the prompt information used to prompt the user to set the instant payment function.

23. The method according to claim 21, wherein the method further comprises:
determining whether the instant payment function is enabled for a user account of the payment application in the mobile terminal; and
the displaying prompt information used to prompt a user to set an instant payment function specifically comprises:
if the instant payment function is not enabled for the user account, displaying first prompt information used to prompt the user to enable the instant payment function.

24. The method according to claim 23, before the displaying first prompt information used to prompt the user to enable the instant payment function, further comprising:
determining whether the user account is a highly active user account, wherein
the displaying first prompt information used to prompt the user to enable the instant payment function specifically comprises:
if the user account is a highly active user account, displaying the first prompt information used to prompt the user to enable the instant payment function.

25. The method according to claim 14, wherein the tag information comprises an application identifier of the payment application; and the starting a payment application in the mobile terminal based on the tag information specifically comprises:
starting the payment application in the mobile terminal based on the application identifier.

26. The method according to claim 15, wherein the tag information comprises link information, and the link information comprises information used to display the payment prompt page; and the displaying a payment prompt page based on the tag information specifically comprises:
displaying the payment prompt page based on the link information.

27. The method according to claim 26, wherein the link information further comprises an application identifier of the payment application.

28. A payment method based on near field communication, comprising:
obtaining, by a server, a payment information obtaining request generated by a mobile terminal with a near field communication function based on obtained tag information in an NFC tag, wherein the tag information is used to trigger a payment procedure;
generating, based on the payment information obtaining request, transaction identification information used to indicate user payment account information in the mobile terminal; and
sending the transaction identification information to a payment device associated with the NFC tag, wherein the payment device is configured to execute a payment procedure based on the transaction identification information.

29. A near field communication-based payment method, comprising:
obtaining, by a server, a payment processing request sent by a mobile terminal, wherein the payment processing request is sent by a payment application started by the mobile terminal based on tag information in an NFC tag;
processing a payment service based on the payment request to generate payment result information; and
feeding back the payment result information to the mobile terminal.

30. The method according to claim 29, wherein the processing a payment service based on the payment request specifically comprises:
generating, based on the payment processing request, transaction identification information used to indicate user payment account information in the mobile terminal; and
sending the transaction identification information to a payment device, so that the payment device executes a payment procedure based on the transaction identification information.
